(19) United States
(12) Patent Application Publication
(10) Pub. No.: US 2010/0017306 A1
(43) Pub. Date: Jan. 21, 2010

(54) MERCHANDISE DEALING SYSTEM AND COMPUTER

(75) Inventor: Jun Hoshii, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/503,725

(22) Filed: Jul. 15, 2009

(30) Foreign Application Priority Data
Jul. 15, 2008 (JP) 2008-184249
Jun. 10, 2009 (JP) 2009-139460

(51) Int. Cl. G06Q 30/00; G06Q 10/00

(52) U.S. Cl. 705/27; 705/30

(57) ABSTRACT

A merchandise dealing system includes computers which are provided for a purchaser, a distributor, an agency store, and a printing manager and are connected to each other via a communication line, wherein the computer of the agency store includes a sample printing unit that prints a merchandise sample by a printing apparatus, an information printing unit that prints identification information on the sample to identify the merchandise, and a consumable goods data transmitting unit that transmits consumable goods data to the computer of the printing manager to specify the consumable goods exhausted by printing the sample, wherein the computer of the purchaser includes a purchasing unit that transmits the identification information printed on the sample to the computer of the distributor, and wherein the computer of the distributor includes a specifying unit that specifies the designated merchandise and the agency store which prints the sample on the basis of the transmitted identification information, and a charging unit that charges the cost of the specified merchandise to the purchaser, and wherein the computer of the printing manager includes a consumable goods supplementing unit that receives the consumable goods data and supplements the consumable goods exhausted by printing the sample, and an accounting unit that charges the cost of the supplemented consumable goods to the distributor.

This application claims priority to Japanese Patent Application No. 2008-184249, filed Jul. 15, 2009 and Japanese Patent Application No. 2009-139460, filed Jun. 10, 2009. The entirety of each of the aforementioned applications are incorporated herein by reference.

### BACKGROUND

1. Technical Field

The present invention relates to a merchandise dealing system and a computer, and more specifically to a merchandise dealing system and a computer which can purchase goods using a sample.

2. Related Art

An on-demand printing system is proposed in which, when printing is needed, a customer requests as much printing as is needed and the price corresponding to the amount of printing is charged (refer to JP-A-2006-146687). In this case, the customer may pay the price of the printed materials in a scheme of charging the cost by including it with the printing service. The printing vendor can make a profit by including the cost of the materials and the service necessary for printing into the price.

However, it is conceivable that the printed material is used in the deal but does not become a transaction object. For example, a merchandise catalog or the like would not be the transaction object. In such a case, the price for the merchandise catalog is not paid by the purchaser directly. Therefore, there is a problem that the printing vendor cannot recoup the cost of the consumable goods which are exhausted when the merchandise catalog is printed. In addition, there is a problem that the consumable goods are not properly supplemented, so that the consumable goods run out of stock.

### SUMMARY

An advantage of some aspects of the invention is to provide a merchandise dealing system and a computer in which the consumable goods of sample printing can be supplemented.

According to an aspect of the invention, there is provided a merchandise dealing system including computers which are provided for a purchaser, a distributor, an agency store, and a printing manager and are connected to each other via a communication line, wherein the computer of the agency store includes a sample printing unit that prints a merchandise sample by a printing apparatus, an information printing unit that prints identification information on the sample to identify the merchandise, and a consumable goods data transmitting unit that transmits consumable goods data to the computer of the printing manager to specify the consumable goods exhausted by printing the sample, wherein the computer of the purchaser includes a purchasing unit that transmits the identification information printed on the sample to the computer of the distributor, and wherein the computer of the distributor includes a specifying unit that specifies the designated merchandise and the agency store which prints the sample on the basis of the transmitted identification information, and a charging unit that charges the cost of the specified merchandise to the purchaser, and wherein the computer of the printing manager includes a consumable goods supplementing unit that receives the consumable goods data and supplements the consumable goods exhausted by printing the sample, and an accounting unit that charges the cost of the supplemented consumable goods to the distributor.

### BRIEF DESCRIPTION OF THE DRAWINGS

The invention will be described with reference to the accompanying drawings, wherein like numbers reference like elements.

FIG. 1 is an overall configuration diagram illustrating a paint purchasing system.

FIG. 2 is a block diagram illustrating a hardware configuration of a computer.

FIG. 3 is a block diagram illustrating a software configuration of a paint purchasing system.

FIG. 4 is a flowchart illustrating entire processes performed by a paint purchasing system.

FIG. 5 is a flowchart illustrating an initial setting process.

FIG. 6 is a flowchart illustrating a sample sheet printing process.

FIG. 7 is a view illustrating an example of a UI image for designating a paint.

FIG. 8 is a view illustrating print data.

FIG. 9 is a view illustrating an index table.

FIG. 10 is a view illustrating a data structure of each pixel.

FIG. 11 is a flowchart illustrating a purchasing process.

FIG. 12 is a view illustrating an example of a purchasing UI image.

FIG. 13 is a flowchart illustrating a delivery accounting process.

FIG. 14 is a view illustrating an example of an agency store database SDB.

FIG. 15 is a flowchart illustrating a consumable goods supplementing process.

FIG. 16 is a view illustrating a software configuration for an index table creating process.

FIG. 17 is a flowchart illustrating an index table creating process.

FIG. 18 is a view illustrating a software configuration for a calibration process.

FIG. 19 is a flowchart illustrating a calibration process.

FIG. 20 is a view illustrating an example of a color chart.

FIG. 21 is a graph illustrating deviation in a spectral reflectance.

FIG. 22 is a view schematically illustrating a calculation of a Jacobian matrix J.

FIG. 23 is a view schematically illustrating a printing method of a printer.

FIG. 24 is a view illustrating a database for a spectral reflectance.

FIG. 25A is a view illustrating a spectral Neugebauer model.

FIG. 25B is a view illustrating a Murray-Davies model.

FIG. 26A is a view illustrating a cellular Yule-Nielsen Spectral Neugebauer Model.

FIG. 26B is a view illustrating a relationship between ink area coverage and an ink amount in a cell division model.

FIG. 26C is a view illustrating a calculation method of a prediction of spectral reflectance.

FIG. 27 is a view illustrating a configuration of a designation module according to a modified example.

FIG. 28 is a flowchart illustrating a designation process according to a modified example.

FIG. 29 is a view schematically illustrating a weighting function according to a modified example.

FIG. 30 is a flowchart illustrating a designation process according to a modified example.

FIG. 31 is a view illustrating an example of a region designating image according to a modified example.

FIG. 32 is a view illustrating a software configuration of an application according to a modified example.

FIG. 33 is a flowchart illustrating a sorting-out process according to a modified example.

FIG. 34 is a view illustrating an example of a condition designating image according to a modified example.

FIG. 35 is a view illustrating an example of an index table according to a modified example.

FIG. 36 is a view illustrating another display example of a patch according to a modified example.

FIG. 37 is a view illustrating a software configuration of a paint purchasing system according to a modified example.

FIG. 38 is a view illustrating a software configuration of a paint purchasing system according to a modified example.

FIG. 39 is a view illustrating a software configuration of a paint purchasing system according to a modified example.

### DESCRIPTION OF EXEMPLARY EMBODIMENTS

In the following, an embodiment according to the invention will be described in accordance with the procedure as follows:

A. Overall Configuration:

B. Sample Sheet Printing Process:

C. Purchasing Process:

D. Delivery Accounting Process:

E. Consumable Goods Supplementing Process:

F. Ink Amount Set:

F1. Index Table Creating Process:

F2. Calibration Process:

G. Spectral Printing Model:

H. Modified Example:

H1. First Modified Example:

H2. Second Modified Example:

H3. Third Modified Example:

H4. Fourth Modified Example:

H5. Fifth Modified Example:

H6. Sixth Modified Example:

H7. Seventh Modified Example:

I. Conclusion

### A. Overall Configuration

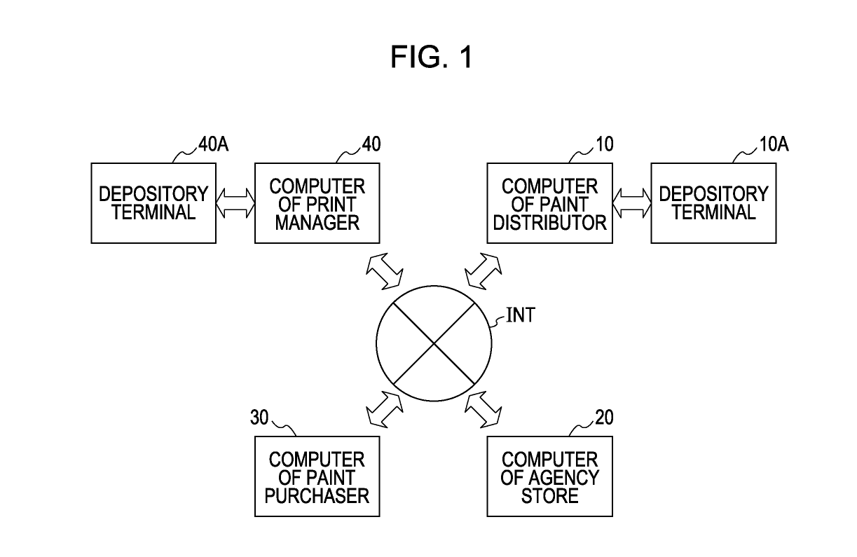

FIG. 1 schematically shows computers constituting a paint dealing system and a sales accounting system of the invention, and a network. In the drawing, the invention is configured to include at least a computer 10 of a paint distributor, a computer 20 of an agency store, a computer 30 of a paint purchaser, and a computer 40 of a printer maker, and all of which are connected to each other and are capable of communicating via the Internet INT. Further, the printer maker corresponds to a printing manager of the invention. In this embodiment, the respective computers 10, 20, 30, and 40 are illustrated to be connected to each other via the Internet INT, but all or a part of the communication lines may be configured by interposing another communication medium (communication protocol) such as a wire/wireless telephone line. In addition, the computer 10 of the paint distributor may be connected to a depository terminal 10A via the Internet INT or a LAN (not shown) Similarly, the computer 40 of the printer maker is also connected to a depository terminal 40A via the Internet INT or the LAN (not shown).

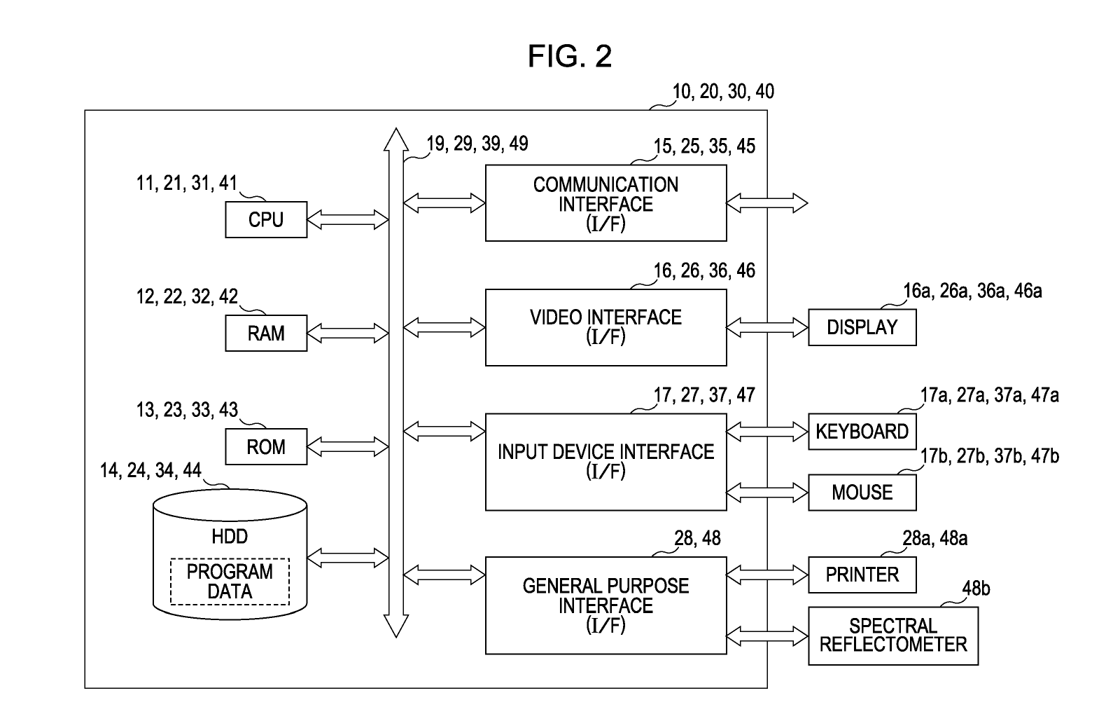

FIG. 2 shows an example of a hardware configuration of the computers 10, 20, 30, and 40. The computers 10, 20, 30, and 40 in this embodiment include the similar hardware configuration. The computers 10, 20, 30, and 40 are configured to include CPUs 11, 21, 31, and 41, RAMs 12, 22, 32, and 42, ROMs 13, 23, 33, and 43, hard disk drives (HDD) 14, 24, 34, and 44, communication interfaces (I/F) 15, 25, 35, and 45, video interfaces (I/F) 16, 26, 36, and 46, input device interfaces (I/F) 17, 27, 37, and 47, general purpose interfaces (I/F) 28 and 48, and buses 19, 29, 39, and 49. The CPUs 11, 21, 31, and 41 develop program data stored in the ROMs 13, 23, 33, and 43 and the HDDs 14, 24, 34, and 44 to the RAMs 12, 22, 32, and 42, and perform a calculation for performing processes and functions, which will be described later. The communication I/Fs 15, 25, 35, and 45 act as an intermediary for connecting the computers 10, 20, 30, and 40 to the Internet INT. The video I/Fs 16, 26, 36, and 46 perform a process for outputting a video to external displays 16a, 26a, 36a, and 46a. The input device I/Fs 17, 27, 37, and 47 accept operations on external keyboards 17a, 27a, 37a, and 47a or external mouses 17b, 27b, 37b, and 47b and transmit signals based on the operations to the CPUs 11, 21, 31, and 41.

The general purpose I/Fs 28 and 48 provided at the computers 20 and 40 of the printer maker of the agency store serve to provide interfaces for connecting external printers (print apparatus) 28a and 48a to the computer 20. The general purpose I/F 48 provided at the computer 40 of the printer maker serve to provide the interface for controlling a spectral reflectometer 48b. Further, in this embodiment, the printer 48a connected to the computer 40 of the printer maker and the printer 28a connected to the computer 20 of the agency store are the same model. It is assumed that the printer 48a is a standard machine. The above-mentioned constituent elements 11 to 17, 21 to 28, 31 to 37, and 41 to 48 are connected to each other capable of communicating via the buses 19, 29, 39, and 49 and by communicating to each other the constituent elements 11 to 17, 21 to 28, 31 to 37, and 41 to 48 can be configured to perform processes in cooperation with each other. Further, in the computers 10 and 30, the printer may not be connected thereto. The agency store is an agency store which acts as an intermediary in the paint sale, and the computer 20 is provided at the agency store. Further, the computer 20 of the agency store and the computer 30 of the paint purchaser are each illustrated as a single computer, respectively, but there may be a large number of paint purchasers, agency stores, and paint distributors, and the computers 20 and 30 are provided in proportion thereto. The computer 40 of the printer maker serves to manage the respective printers 28a connected to the computer 20 of the respective agency stores.

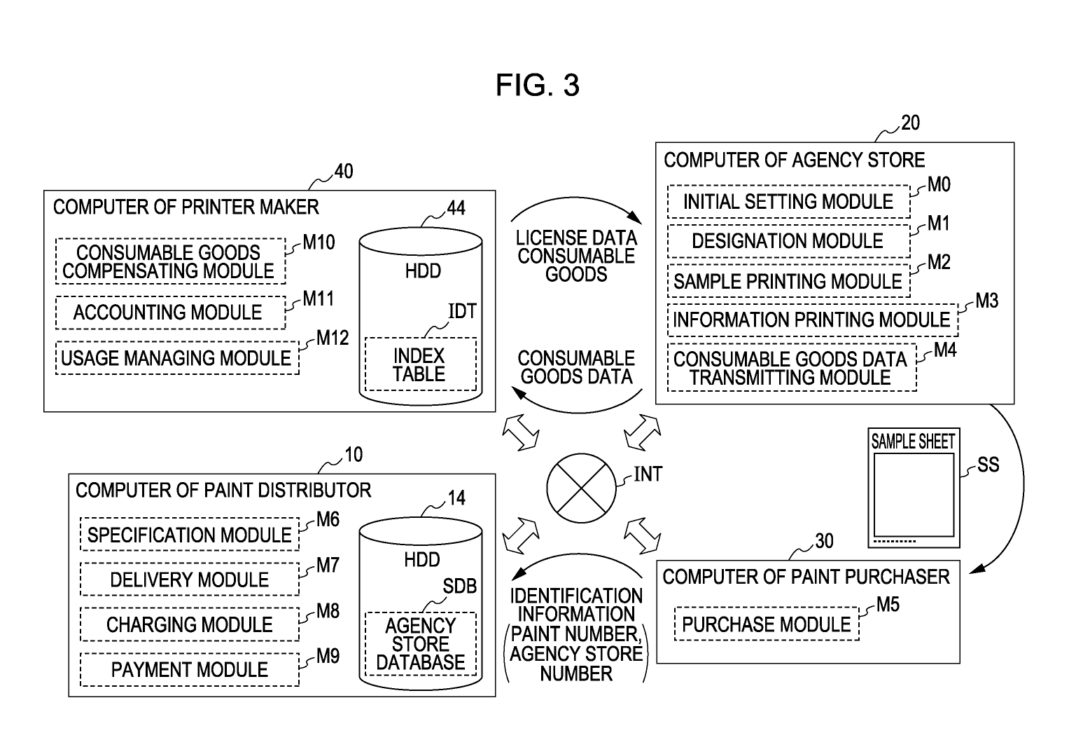

FIG. 3 shows principal data and software configurations provided in the computers 10, 20, 30, and 40. First, in the computer 20 of the agency store, an initial setting module M0, an designation module M1, a sample printing module M2, an information printing module M3, and a consumable goods data transmitting module M4 are performed. A purchase module M5 is performed in the computer 30 of the paint purchaser. In the computer 10 of the paint distributor, a specification module M6, a delivery module M7, a charging module M8, and a payment module M9 are performed. A consumable goods supplementing module M10, an accounting module M11, and a usage managing module M12 are performed in the computer 40 of the printer maker. The initial setting module M0 performs an initial setting for performing a sample sheet printing process, and more particularly, performs a process of designating a paint distributor using the sample sheet SS. The designation module M1 accepts designation of the paint carried by the paint purchaser who visits the agency store in which the computer 20 is provided. In the agency store, for example, the samples (a wood, a plastic, a stone, and the like coated with the respective paints) of the paints are provided, and the paint purchaser may designate the paint sample which has a favorite color or a favorite texture. Each of the samples is attached with a unique paint number (identification information of the invention) of the corresponding paint, so that designation of the paint is accepted by inputting the paint number to the computer 20.

The sample printing module M2 acquires a paint number of the designated paint, and prints the sample of the paint according to an ink amount set corresponding to the paint number. The printer 28a according to this embodiment is an ink jet printer which can eject an ink as a coloring material by any combination of the ink colors C (cyan), M (magenta), Y (yellow), K (black), lc (light cyan), and lm (light magenta). By designating (an ink amount set φ) the combination of the CMYKlclm ink amounts, the printer 28a realizes a dot recording rate of each ink according to the ink amount on a recording medium (a glossy paper in this embodiment). As a result, it is possible to realize a color (a spectral reflectance) approximating to any paint on the glossy paper. In the HDD 44 of the computer 40 of the printer maker, an index table IDT is stored as a database according to the invention, in which a correspondence relationship between the paint number and the ink amount set is defined in the index table IDT.

The ink amount set defined in the index table IDT is configured to eliminate deviation in the characteristics of the ink ejection which mainly depends on an individual printer 28a and is configured in consideration of a fine adjustment (a calibration process to be described later) for matching with the output characteristics of an ideal standard machine. The information printing module M3 performs a process of printing the paint distributor, the paint number, and a unique agency store number (identification information of the invention) of the agency store using characters in addition to the sample of the paint described above. The consumable goods data transmitting module M4 acquires the glossy paper and the ink amount of each of the CMYKlclm which are the consumable goods exhausted by printing the sample, and transmits the consumable goods data which specifies the kinds and the amount of the exhausted consumable goods to the computer 40 of the printer maker via the Internet INT.

The purchase module M5 performed in the computer 30 of the paint purchaser performs a predetermined UI display to accept inputs such as the paint distributor who deals in the paint which the paint purchaser wants to buy, the paint number, and the agency store number. The specification module M6 performed in the computer 10 of the paint distributor acquires the paint number and the agency store number which are transmitted by the purchase module M5, and specifies the paint as the purchase object on the basis of the paint number. As a result, the delivery module M7 can specify the paint which is delivered to the paint purchaser, and perform a process of delivery. When the purchase content is specified by the specification module M6, the charging module M8 calculates a price corresponding to the purchase content, and performs a process of charging the price to the paint purchaser. The payment module M9 acquires the purchase content and the agency store number, and specifies the agency store where the sample of the purchased paint is printed on the basis of the agency store number. Then, a process of paying the price for printing the sample is performed on the specified agency store. The consumable goods supplementing module M10 performed by the computer 40 of the printer maker receives the consumable goods data which is transmitted from the consumable goods data transmitting module M4, and performs a process of supplementing the consumable goods on the agency store on the basis of the consumable goods data. The usage managing module M12 monitors the designation module M1, the sample printing module M2, the information printing module M3, and the consumable goods data transmitting module M4 which are performed on the computer 20 of the agency store, and issues license data LD which substantially allows these modules to function. The accounting module M11 performs a process of charging the cost of the supplemented consumable goods and the cost of the license data LD to the paint distributor.

### B. Sample Sheet Printing Process

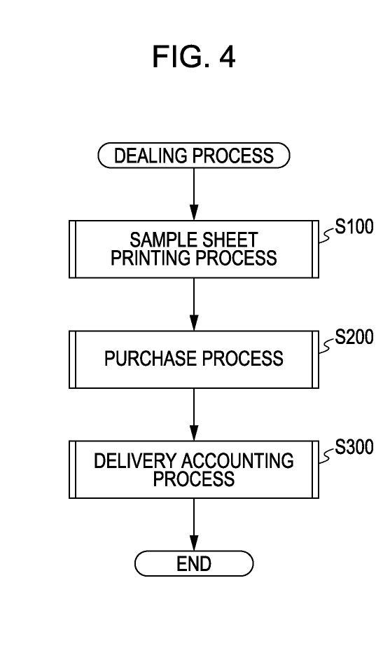

FIG. 4 shows a flow schematically illustrating the paint dealing process which is performed by the merchandise dealing system of the invention. In this embodiment, a sample sheet printing process (step S100) is first performed in the computer 20 of the agency store. Next, a purchasing process (step S200) is performed in the computer 30 of the paint purchaser. Furthermore, a delivery accounting process (step S300) is performed in the computer 10 of the paint distributor. Here, the sample sheet printing process (step S100) will be described first. As an assumption for performing each process described above, the initial setting process (step S10) is performed in advance. The initial setting process is a process of carrying out setting necessary to perform the sample sheet printing process in the computer 20 of the agency store on the computer 10 of the paint distributor, the computer 20 of the agency store, and the computer 40 of the printer maker.

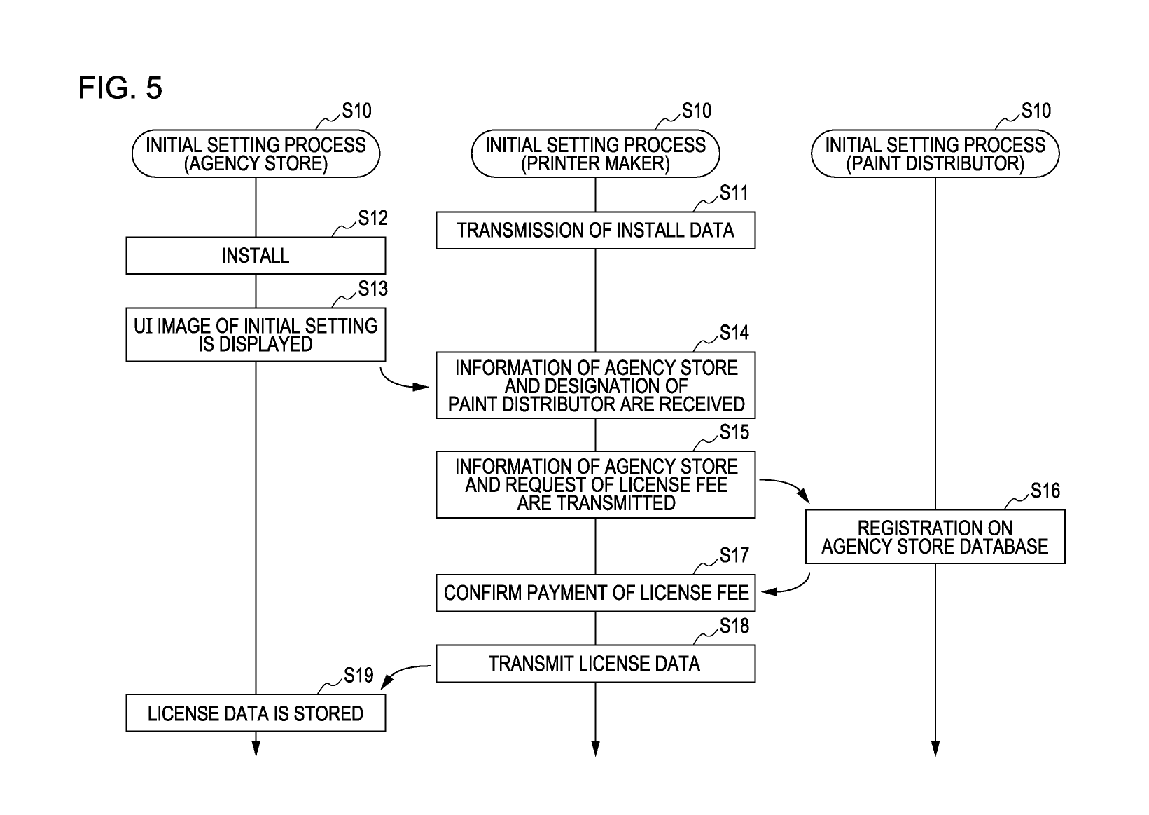

FIG. 5 shows a flow of the initial setting process. In step S11, installation data of the initial setting module M0, the designation module M1, the sample printing module M2, the information printing module M3, and the consumable goods data transmitting module M4 necessary to perform the sample sheet printing process are transmitted from the usage managing module M12 performed by the computer 40 of the printer maker to the computer 20 of the agency store via the Internet INT. In step S12, the installation data is installed on the computer 20 of the agency store. Further, when the initial setting module M0, the designation module M1, the sample printing module M2, the information printing module M3, and the consumable goods transmitting module M4 are already installed, steps S11 to S12 are canceled.

When the installation is completed, the initial setting module M0 starts in step S13, and displays a UI image for the initial setting on the display 28a. In the UI image, at least a display for inputting information (the unique agency number of the agency store, the name of the agency store, a payment method from the paint distributor to the agency store, etc.) on the agency store and a display for designating the paint distributor as a partner are provided. For example, when plural paint distributors exist, the desired paint distributor is selected among them as the partner. In step S14, the usage managing module M12 of the computer 40 receives the designated paint distributor and the information on the agency store. Then, in step S15, the usage managing module M12 transmits the information on the agency store and a payment request of the license fee to the computer 10 of the designated paint distributor. The license fee means a royalty for using the respective modules M1 to M4 necessary to carry out the sample sheet printing process for a specific period of time (for example, one year). In step S16, the computer 10 of the paint distributor receives the information regarding the agency store such as the unique agency store number or the name of the agency store, or the payment method from the paint distributor to the agency store, and registers the information on the agency store database SDB which is stored in the HDD 14 of the computer 10 of the paint distributor.

In addition, in step S15, the computer 10 of the paint distributor, which receives the information on the agency store and the payment request of the license fee, can grasp which agency store started the dealing, and can determine whether or not the license fee is paid for the agency store. In step S17, the usage managing module M12 of the computer 20 determines whether or not the payment of the license fee is completed. When the payment is completed, the license data LD is transmitted to the computer 20 of the agency store. In step S19, the license data LD is stored in the HDD 24 of the computer 20. Further, whether or not the payment of the license fee is completed can be determined according to whether or not the settlement corresponding to the transmitted payment request is completed in step S15, for example, by connecting to the electronic money settlement server or the credit card settlement server, which are not shown in the drawing. For example, it is possible to determine the above according to whether or not the unique bill number is designated in the payment request in step S15 and the settlement of the specified bill number is settled. It is preferable that the license data LD is encoded so as not to be manipulated.

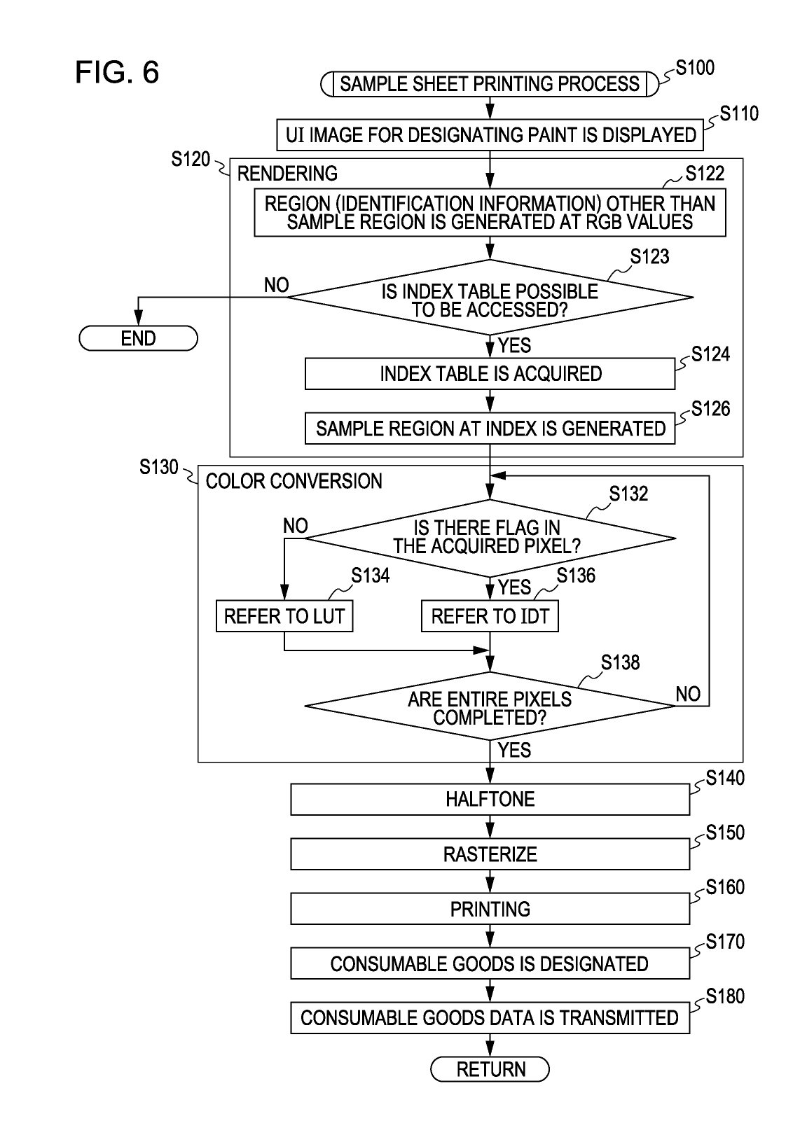

FIG. 6 shows a flow of the sample sheet printing process. The sample sheet printing process is performed in the computer 20 of the agency store in which the above-mentioned initial setting process is already completed, and specifically is performed by the designation module M1, the sample printing module M2, the information printing module M3, and the consumable goods data transmitting module M4. In step S110, the designation module m1 displays a predetermined UI image on the display 26a, and accepts designation of the paint number from the paint purchaser who visits the agency store.

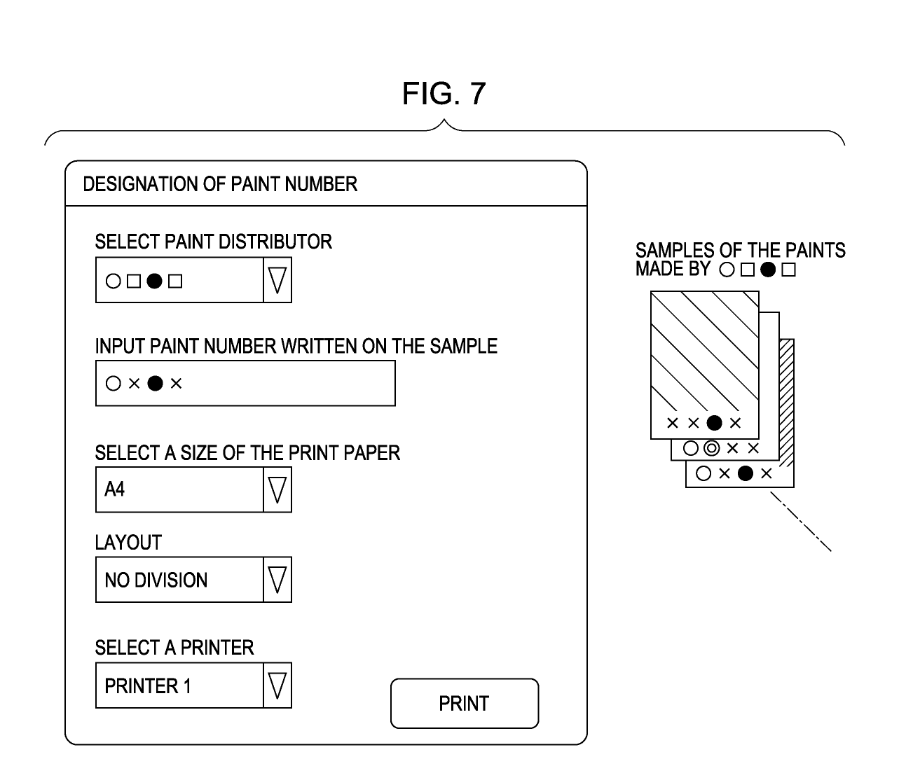

FIG. 7 shows an example of the UI image. As shown in the drawing, a pull down menu is provided in the UI image to select the paint distributor, and thus the paint distributor from whom the paint is purchased can be selected. The agency store may perform the initial setting process described above in relation to plural paint distributors in some cases. In this case, it is possible to cause the plural paint distributors to sell a desired paint. Furthermore, a text box is provided in the UI image, and thus it is possible to input the paint number in the text box using the keyboard 27a. As described above, the paint samples are disposed in the agency store, and the paint purchaser can identify the paint number which is written on each sample. In addition, the agency store handles the paints of the plural paint distributors, the samples are provided at every paint distributor, and thus it is possible for the paint purchaser to decide to purchase any paint number of any paint distributor.

The paint purchaser selects a favorite one among the samples, selects the paint distributor in the UI image, and inputs the paint number written on the sample to the text box. In addition, in the UI image, pull-down menus are provided to designate a print paper size, a layout, and the printer 28a, so that these can be designated. For example, it is possible to designate two kinds of paint samples to be arranged on the A3 paper. Further, this embodiment will be described such that one sample is designated to be arranged on the A4 paper. A print button is provided on the UI image, and the designation module M1 accepts the click of the print button. When the designation module M1 accepts the click of the print button, the sample printing module M2 and the information printing module M3 start the rendering of the print data PD and print the sample sheet SS in step S120.

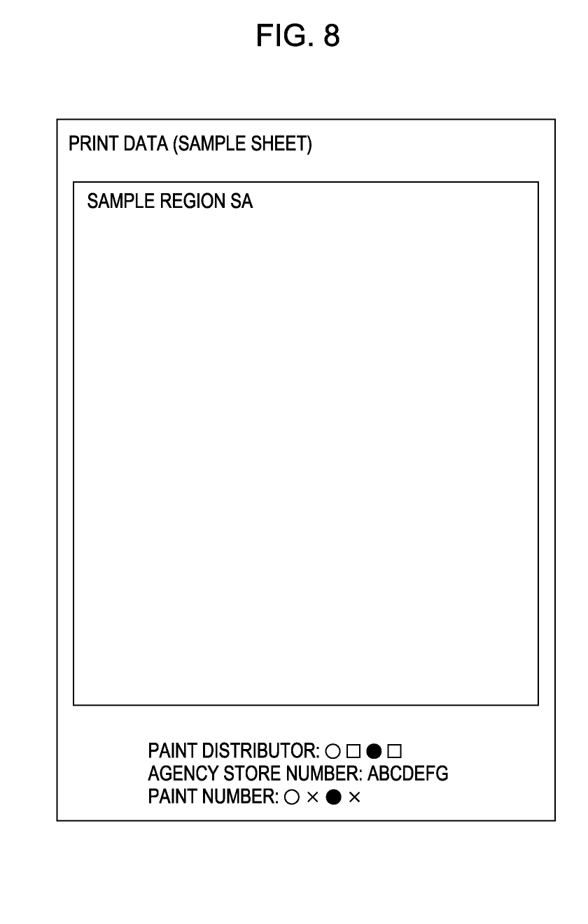

FIG. 8 schematically shows the print data PD (sample sheet SS). The print data PD is image data representing an image corresponding to the sample sheet SS. The print data PD is configured of a large number of pixels which are arranged in a dot matrix. Each pixel includes 4 bytes (8 bits×4) of information. In the center portion of the print data PD, a sample region SA is provided in a rectangular shape for printing the paint sample having the designated paint number. On the lower side of the sample region, character strings are generated to represent the designated paint distributor, the paint number, and the agency store number. In step S122, the information printing module M3 first generates the image data of a frame-shaped region on the outside of the sample region SA on the basis of designation of the print paper size and the layout. The pixels constituting the frame-shaped region on the outside of the sample region SA store the RGB values using 3 bytes out of 4 bytes. Specifically, 1 byte is used for storing 8 bits of the R value, 1 byte is used for storing 8 bits of the G value, 1 byte is used for storing 8 bits of the B value, and the remaining 1 byte is not used.

For example, when the frame-shaped region on the outside of the sample region SA is displayed in a white color, the print data PD is generated such that the pixels of the frame-shaped region have the information (R, G, B)=(255, 255, 255). When the character strings representing the paint number and the agency store number are displayed with the black color, the print data PD is generated such that the pixels corresponding to the character strings have the information (R, G, B)=(0, 0, 0). In the next step S124, the sample printing module M2 performs a process of generating the pixels belonging to the sample region SA. In step S123, the sample printing module M2 accesses the index table IDT which is stored in the HDD 44 of the computer 40 of the printer maker. A large number of index tables IDT are stored in the HDD 44 of the computer 40, and, among these index tables, access to the index tables corresponding to the paint distributor designated in the above-mentioned UI image and the printer 28a is tested.

Access to the index table IDT stored in the HDD 44 of the computer 40 is limited by the usage managing module M12 which is performed on the computer 40. Access is not allowed unless the access request is performed together with the effective license data LD. The license data LD is issued by the initial setting process describe above, and is not issued to the paint distributor unless the designated paint distributor pays the license fee to the printer maker. Here, when access is not allowed, the process is ended with an error. That is, the effective initial setting (payment of the license fee) is not performed between the designated paint distributor and the agency store, and the process is ended. That is, when the effective license data LD is not provided, the sample printing module M2 and the information printing module M3 do not function substantially. On the other hand, when the access is allowed, the sample printing module M2 in step S124 performs a process of generating pixels belonging to the sample region SA.

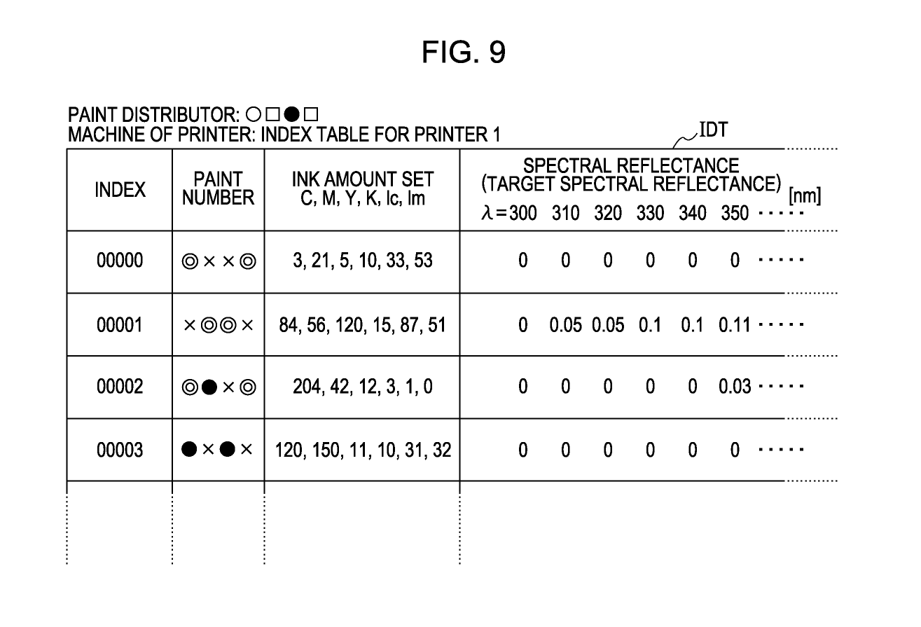

FIG. 9 shows an example of the index table IDT. In the index table IDT illustrated in the drawing, the correspondence relationship among the paint distributor (the name or the unique number), a machine number of the printer 28a, the paint number, the index, and the ink amount set which means the combination of the CMYKlclm ink amounts, is defined. In addition, each paint number is associated with a target spectral reflectance Rₜ(λ) which is described later. Further, the paint number and the index are both unique. In this embodiment, the paint number and the index are provided independently from each other, but the index can also be used as the paint number. The ink amount set defined in the index table IDT reproduces the same spectral reflectance characteristics as those of the paint associated with the paint number, and the details of which will be described in an index table creating process and a calibration process. In step S124, first, with reference to the index table IDT, the index corresponding to the designated paint number is acquired. Then, the index is stored in each pixel belonging to the sample region SA. The region storing the index in each pixel uses 3 bytes storing the RGB values in pixels other than the sample region SA, a flag including instructions relating to storing the index is stored in the remaining 1 byte. In this embodiment, a single paint number is designated, and the sample region SA is filled with the same pixels storing the index corresponding to the single paint number.

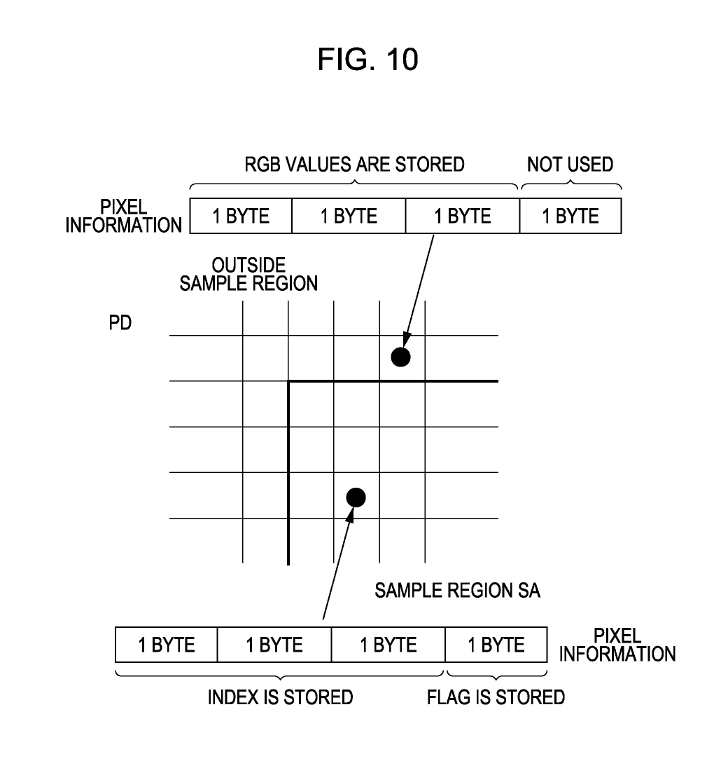

FIG. 10 schematically shows the data structure of each pixel. As shown in the drawing, in the pixels other than the sample region SA, the RGB values are stored using 3 bytes. On the other hand, in the pixels in the sample region SA, the index is stored using 3 bytes and the flag is stored using the remaining 1 byte. As described above, when the rendering of the print data PD is completed, the sample printing module M2 performs a color conversion process on the print data PD in step S130. First, in step S132, the sample printing module M2 acquires the pixel of the print data PD, and determines whether or not the above-mentioned flag is appended to the pixel. Then, when the flag is not appended, the sample printing module M2 refers to a color conversion table LUT stored in the HDD 24 to convert the print data PD into the ink amount set of the CMYKlclm corresponding to the RGB values stored in the pixel (step S134). Specifically, an interpolation calculation is carried out using information on a grid point defined in the color conversion table LUT to acquire the ink amount set corresponding to the RGB values. Further, the color conversion table LUT is a look-up table which is referred to when the printer 28a prints a general print material. For example, the look-up table is created by a technique disclosed in JP-A-2007-336198. According to the technique, it is possible to create a color conversion table LUT which is a good combination of gradation of a reproduced color, graininess, light-source independency of a reproduced color, gamut, and ink duty.

On the other hand, when the flag is appended, the sample printing module M2 refers to the index table IDT to convert the print data PD into the ink amount set corresponding to the index stored in the pixel (step S136). In step S138, it is determined whether or not the color conversion is completed on all of the pixels. When the color conversion is not completed, the process returns to step S132, and the next pixel is subjected to the color conversion. By repeating the above-mentioned processes, all the pixels are finally converted into the print data PD which has the ink amount set of the CMYKlclm. In step S140, the sample printing module M2 performs a halftone process on the color-converted print data PD.

Since all the pixels of the print data PD are converted into the pixel data of the ink amount set by the color conversion in step S130, the halftone process can be uniformly carried out. For example, with a dither method or a random dither method, the multi-gradation ink amount set is made to be low gradation data (gradation where the ejection of a single size dot or a multiple size dot is available). Furthermore, a rasterizing process is performed in step S150 to assign the print data PD subjected to the halftone process to each path or each nozzle of the print head provided at the printer 28a. Therefore, the print data PD available to the printer 28a is created and the printer 28a performs printing on the basis of the print data PD in step S160. Accordingly, the sample sheet SS can be printed on the glossy paper which is set on the printer 28a in advance.

The sample region SA of the sample sheet SS is printed by forming the dots on the basis of the ink amount set which corresponds to the paint number designated in the index table IDT, so that the same spectral reflectance characteristics as the paint corresponding to the paint number can be implemented. Therefore, by viewing the sample region SA, the paint purchaser can confirm a state where the paint is actually coated. The size of the sample sheet SS can be set to a size of the print paper which the printer 28a can print, and the state of the paint can be confirmed by the sample region SA which has an area larger than that of the sample described above. In addition, since the unique agency store number of the agency store which prints the sample sheet SS and the unique paint number of the paint forming the sample region SA are printed in the sample region SA, the paint purchaser can read this identification information.

As described above, when the sample sheet SS is printed, the consumable goods data transmitting module M4 specifies the amount of the consumable goods exhausted in each printing of the sample sheet SS in step S170. The amount of the consumable goods in the printer 28a can be specified on the basis of the print data PD output by the printer 28a. Since the glossy paper on which the sample sheet SS is printed is exhausted by one sheet for each output of the print data PD, it is possible to specify that the glossy paper of the designated print paper size (A4) is exhausted by one sheet. The CMYKlclm ink amounts exhausted every printing of the sample sheet SS can be obtained by taking the statistics of the number of times each ink represented by the print data PD after the halftone process is ejected. Since the unit amount of ejected ink in one shot can be specified by the specification for the print head of the printer 28a, a consumed ink amount can be specified by multiplying the number of times each ink is ejected and the unit ejecting ink amount together.

In addition, a sensor is provided to detect an ink stored amount of an ink tank for storing the ink, and the consumed ink amount may be specified on the basis of a measurement value of the sensor. The consumable goods data transmitting module M4 transmits the consumable goods data specified in the above-mentioned manner to the computer 40 of the printer maker (step S180). The above-mentioned agency store number is stored in the consumable goods data. Further, in this embodiment, the case where the consumable goods data transmitting module M4 is performed on the computer 20 is shown by way of example. However, the printer 28a may perform the function. That is, when the printer maker manufactures the printer 28a, the function corresponding to the consumable goods data transmitting module M4 may be combined with the printer 28a.

### C. Purchasing Process

The paint purchaser takes the sample sheet SS printed by the above-mentioned sample sheet printing process to his or her own house and attaches or places the sample sheet SS, so that the result when the paint is coated may be confirmed. At this time, the color of the sample region SA may be confirmed under the light source which irradiates the place to be actually coated by the paint. In most cases, the paint purchaser selects plural kinds of the paints as purchasing candidates, and prints the sample sheets SS of the plural paints. The paint purchaser selects a favorite sample sheet SS, and performs a purchasing process for purchasing the paint, with which the sample is printed on the sample sheet SS, by the computer 30.

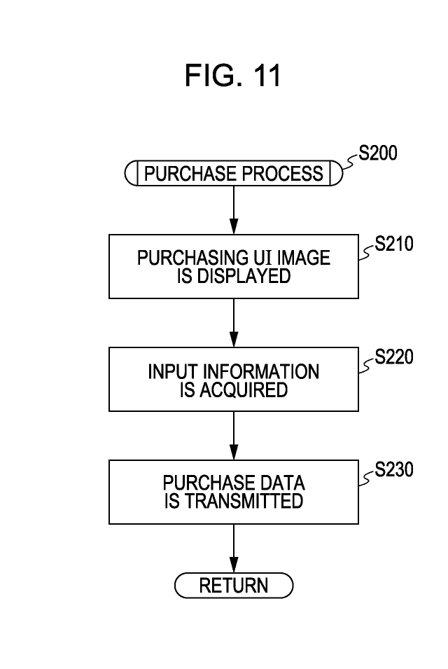

FIG. 11 shows a flow of the purchasing process. The purchasing process is performed by the purchase module M5. The purchase module M5 comes to be in an executable state by installing the installation data, which is downloaded from the computer 40 of the printer maker, in the computer 30. Further, the purchase module M5 is not necessarily installed in the computer 30. For example, the computer 10 of the paint distributor or the computer 40 of the printer maker performs the process of the purchase module M5, and a general-purpose browser or the like executed on the computer 30 may be provided to interface with the paint purchaser. In step S210, the purchase module M5 displays the purchasing UI image on the display 36a to accept the operations of the paint purchaser.

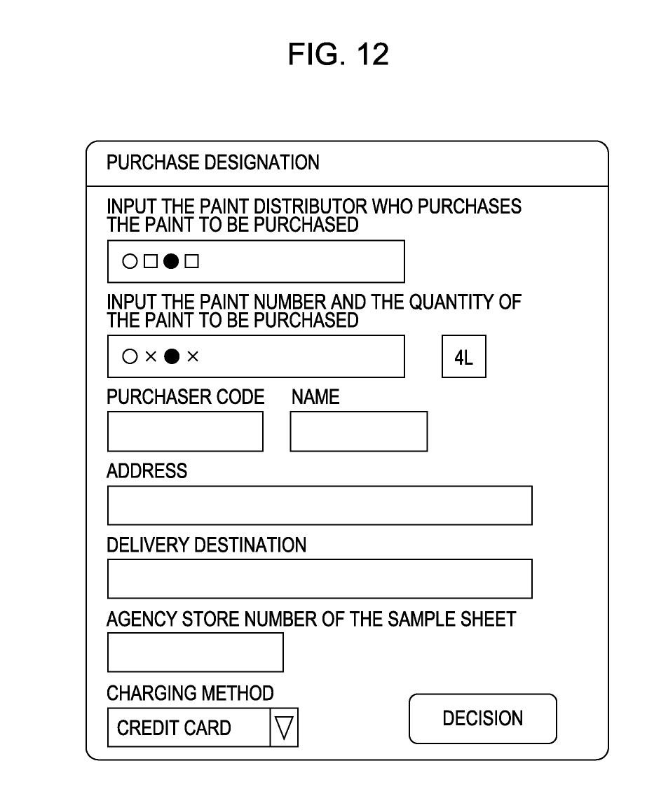

FIG. 12 shows an example of the purchasing UI image. In the UI image, there are provided text boxes which receive the paint distributor (the name or the unique number), private information (purchaser code, name, address, delivery destination) of the paint purchaser, a text box which receives the paint distributor of the paint to be purchased, a text box which receives the paint number of the paint to be purchased, a text box which receives the agency store number, a text box which receives the quantities of the paints to be purchased, a text box which receives the charging method or the like, and a decision button. In step S220, the click of the decision button is detected, and at a point in time when the decision button is clicked, the text information input in each text box is acquired. Then, the purchase module M5 transmits the purchase data (for example, text data, XML data, etc.) including the text information to the computer 10 of the designated paint distributor (step S230). Of course, the data may be subjected to encoding when being transmitted.

### D. Delivery Accounting Process

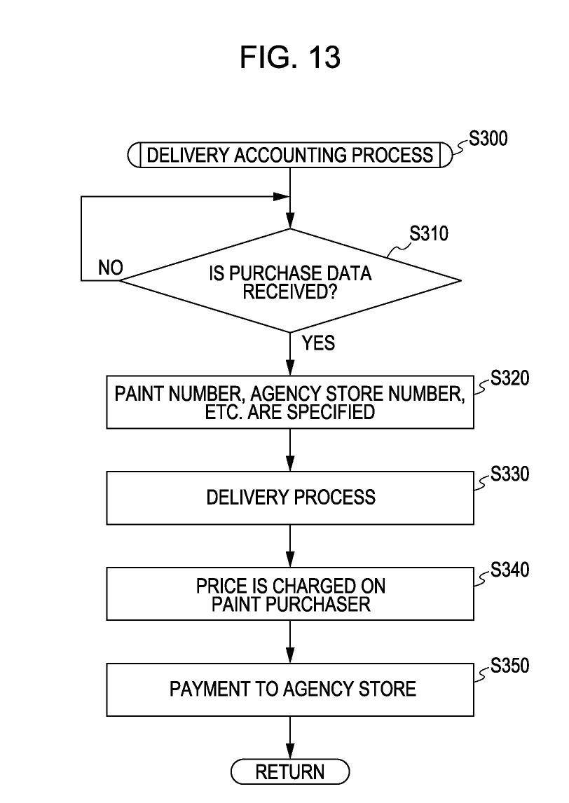

FIG. 13 shows a flow of a delivery accounting process. The delivery accounting process is performed on the computer 10 of the paint distributor, and more specifically, by the specification module M6, the delivery module M7, the charging module M8, and the payment module M9. These modules M6 to M9 are installed in the computer 10 in advance. In step S310, the specification module M6 receives the purchase data transmitted from the purchase module M5. The specification module M6 is on standby in a state capable of receiving the purchase data at any time, and starts the delivery accounting process at the point of receiving the purchase data. In step S320, the specification module M6 specifies the paint number, the agency store number, the purchase quantity, the private information of the paint purchaser, and the charging method.

In step S330, the delivery module M7 performs the delivery process on the basis of the information specified in step S320. The computer 10 of the paint distributor is connected to the depository terminal 10A disposed in the paint depository via, for example, the LAN or the Internet INT. The computer 10 informs the depository terminal 10A of the paint delivered by the delivery module M7, the quantity thereof, and the delivery destination. As a result, it is possible to deliver the paint desired by the paint purchaser in the desired quantity. It is matter of course that a deliver slip is created by the computer 10 and the slip may be transmitted to the depository without using the electronic technique.

In step S340, the charging module M8 calculates the price of the paint to be delivered on the basis of the paint number and the quantity specified in step S320. Specifically, a database is stored in the HDD 14 of the computer 10 of the paint distributor, in which the paint number and the unit price of the respective paints are stored. The unit price of the paint to be delivered is acquired with reference to the database, and is multiplied by the delivery quantity. Furthermore, by adding a delivery charge and a tax, the price to be charged in the purchase of the paint can be calculated. Next, a process of charging the price is performed according to the charging method specified in step S320. For example, the computer 10 of the paint distributor is connected to an electronic money settlement server (not shown) or a credit card settlement server (not shown), which is connected via the Internet INT, and the charging data on the price of the paint is transmitted. According to the process described above, it is possible to deliver the paint to the paint purchaser in the designated quantity, and can charge the price.

In the next step S350, a payment process is performed for acquiring the agency number specified in step S320 and paying (adding) a predetermined amount of money to the agency store associated with the agency store number. In this payment process, firstly, the amount of money to be paid to the agency store is calculated. Here, the payment amount corresponds to the cost of printing the sample sheet SS which is used for purchasing the paint by the paint purchaser. From the paint distributor viewpoint, it can be considered as a reward for making a contribution to the sale of the paint. Furthermore, if the agency store is considered as a retail store handling the paint, it can be also considered as the sale of the agency store. As a method of calculating the amount of money, various other methods can be employed. For example, the amount of money may be also calculated by multiplying the price charged to the paint purchaser in step S340 by a certain ratio. Further, the amount of money may be also calculated by multiplying the money obtained by deducting the cost of the paint from the price. In this way, the amount of money is calculated according to the price charged to the paint purchaser in step S340, so that the amount of money can be paid to the agency store according to the sale of the paint. When the amount of money to be paid to the agent store is calculated as described above, the process is carried out for paying the corresponding amount of money to the agency store which is associated to the agency store number specified in step S320. Here, the payment method registered regarding the agency store is acquired from the agency store database SDB.

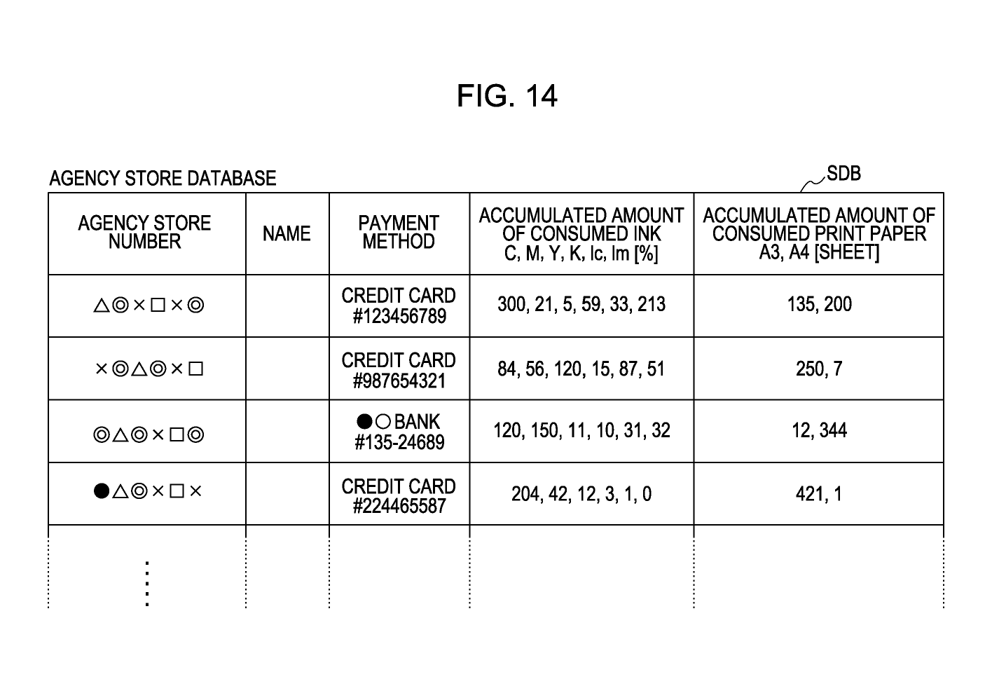

FIG. 14 shows an example of the agency store database SDB. As described above, the respective registration items of the agency store database SDB are registered in the initial setting process when the respective modules M1 to M4 for printing the sample sheet SS are installed in the computer 20 of the agency store. In the agency store database SDB, the correspondence relationship among the agency store number, the name of the agency store, the payment method for the agency store, and the like are stored with respect to each agency store. For this reason, on the basis of the agency store number specified in step S320, the name of the agency store and the payment method can be specified, and the payment can be paid to the agency store which prints the sample sheet SS of the paint to be delivered. Similar to the charge to the paint purchaser described above, the computer of the agency store is connected to an electronic money settlement server (not shown) or a credit card settlement server (not shown), which is connected via the Internet INT, and the requirement for the payment to the agency store is transmitted. Accordingly, the cost of printing the sample sheet SS can be paid to the agency store which prints the sample sheet SS of the paint to be purchased.

### E. Consumable Goods Supplement Process

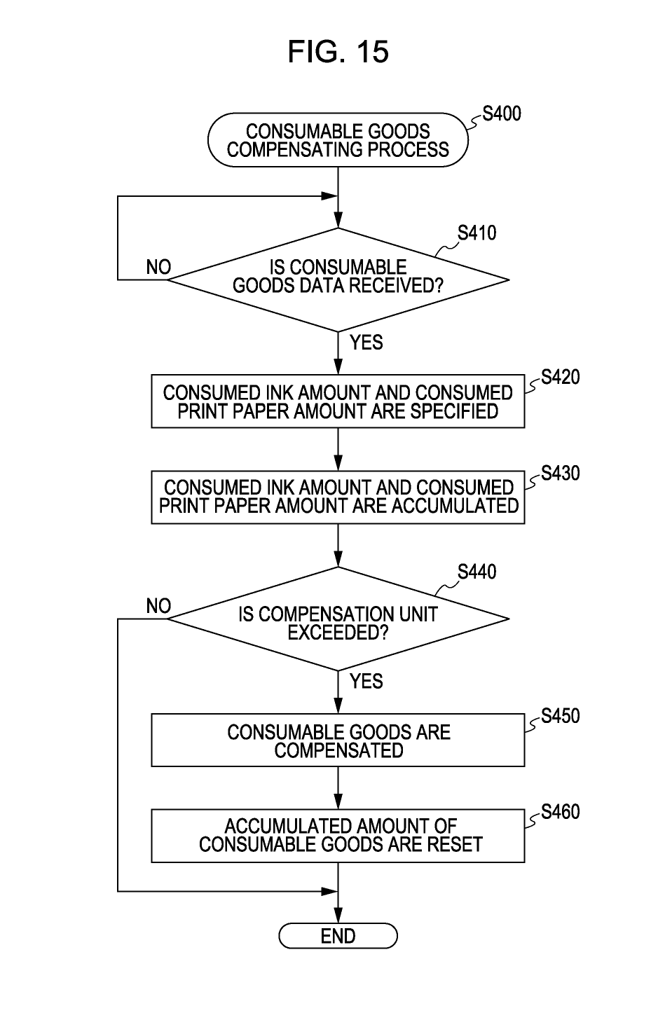

FIG. 15 shows a flow of the consumable goods supplementing process. The consumable goods supplementing process is performed by the consumable goods supplementing module M10 in the computer 40 of the printer maker. Every time the sample sheet SS is printed in the sample sheet printing process described above, the consumable goods data on the consumable goods exhausted in each printing is transmitted to the computer 40 of the printer maker (step S180). The consumable goods supplementing module M10 is on standby in a state capable of receiving the purchase data at any time, and starts the consumable goods supplementing process at a point of receiving the purchase data. In step S410, the consumable goods supplementing module M10 receives the consumable goods data. In step S420, the consumable goods supplementing module M10 specifies the agency store number, the consumed ink amount, and the size of the glossy paper from the consumable goods data. In this embodiment, since the consumable goods data is transmitted every time one sample sheet SS is printed, the amount of the consumed glossy paper (the amount of the consumed print paper) is always one sheet. In step S430, the consumable goods supplementing module M10 acquires the consumed ink amount and the amount of the consumed print paper which are registered on the above-mentioned agency store database SDB regarding the specified agency store. Then, the consumed ink amount and the amount of the consumed print paper which are obtained from the consumable goods data are added to the consumed ink amount and the amount of the consumed print paper which are registered on the agency store database SDB. That is, when the consumable goods data is received, the consumed ink amount and the amount of the consumed print paper are accumulated for every agency store.

In step S440, it is determined whether or not the consumed ink amount and the amount of the consumed print paper which are accumulated exceed a predetermined supplement unit. In this embodiment, the consumable goods are not supplemented every time the consumable goods data is received. However, when the accumulated amounts of the ink and the print paper reach the predetermined supplement unit, the ink and the print paper are supplemented. For example, when the accumulated amount of the consumed ink reaches an amount corresponding to five ink cartridges (500%), the five ink cartridges are supplemented. In addition, when the accumulated amount of the consumed print papers (the glossy papers) reaches 500 sheets, the print papers are supplemented by 500 sheets. When it is determined that the accumulated amount of the consumed ink and the accumulated amount of the consumed printer papers exceed the predetermined supplement unit, the amount of the consumable goods corresponding to the supplement unit is supplemented (step S450). The computer 40 of the printer maker is connected to the depository terminal 40A via, for example, the LAN or the Internet INT, and informs the depository terminal 40A of the consumable goods, which are supplemented by the consumable goods supplement module M10, the amount thereof, and the address of the agency store to be supplemented.

As a result, the consumable goods exhausted in each printing of the sample sheet SS can be supplemented by each supplement unit. In step S460, regarding the supplemented consumable goods, the consumed ink amount and the amount of the consumed print paper which are registered on the agency store database SDB are reset to zero. Therefore, it is possible to prevent the consumable goods such as the print paper or the ink in the agency store from running short. Further, it is possible to prevent the agency store from having to the bear the burden of the consumable goods. In addition, since the consumable goods can be supplemented on the basis of the actually-used amount thereof, the consumable goods should be supplemented at the proper amount and with a proper frequency. In addition, the supplement frequency can be adjusted by changing the supplement unit. Further, in this embodiment, the consumable goods have been supplemented when the amount of the consumable goods reaches a predetermined supplement unit. However, it may be configured such that the paint distributor charges the amount of money corresponding to the actual cost of the consumable goods to the agency store in the payment process described above.

### F. Ink Amount Set

In the sample sheet printing process described above, the sample region SA is printed on the basis of the ink amount set defined in the index table IDT which is created in advance. Here, the index table creating process of creating the index table IDT and the calibration process of correcting the index table IDT once created will be sequentially described. The index table IDT is prepared at the HDD 44 of the computer 40 of the printer maker so as to be created by the computer 40 of the printer maker.

### F1. Index Table Creating Process

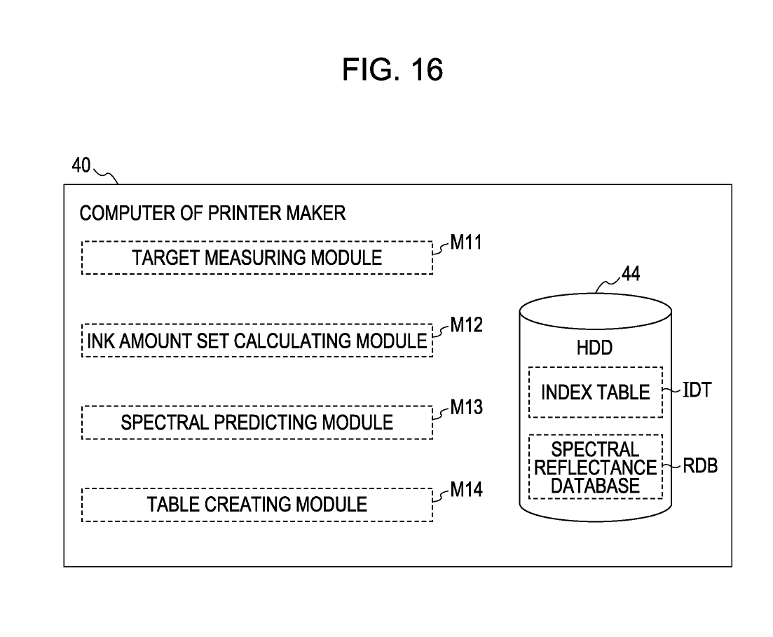

FIG. 16 shows a software configuration of the computer 40 of the printer maker which performs the index table creating process. The computer 40 performs a target measuring module M11, an ink amount set calculating module M12, a spectral predicting module M13, and a table creating module M14 as the software configuration for carrying out the index table creating process. The target measuring module M11 measures the target spectral reflectance Rₜ(λ) that is the spectral reflectance of the sample actually coated with each paint using the spectral reflectometer 48b. Further, the sample used here is the same thing as the sample (a wood, a plastic, a stone, and the like coated with the respective paints) described above. Such a sample is basically created by the paint distributor who manufactures the paint, and is transmitted to the printer maker together with a request for creating the index table IDT. For example, when a paint distributor participates for the first time in the deal, all of the samples are transmitted to the printer maker. When the participating paint distributor develops a new paint or the like, only the new sample is transmitted to the printer maker. The ink amount set calculating module M12 calculates the ink amount set, with which the target spectral reflectance Rₜ(λ) is reproducible, using a spectral printing model to be described later. The table creating module M14 creates the index table IDT which defines the correspondence relationship between the ink amount set calculated by the ink amount set calculating module M12 and the paint number.

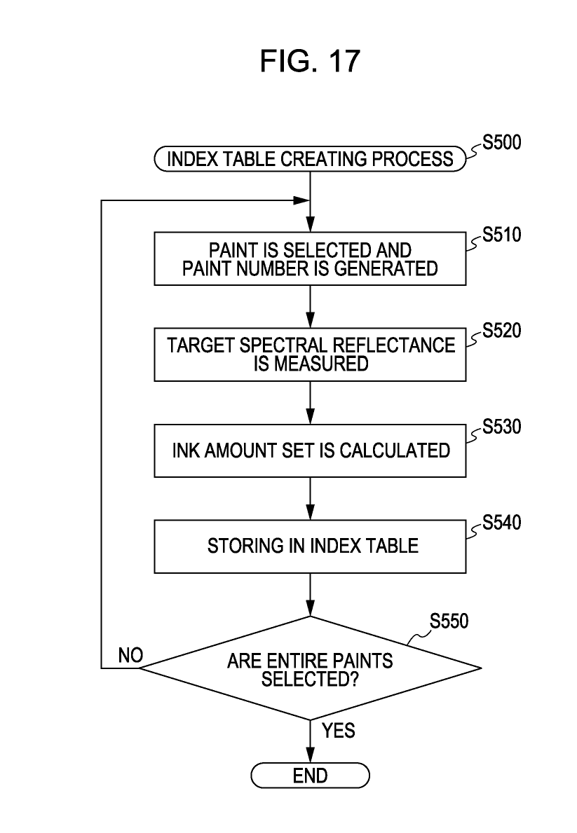

FIG. 17 shows a flow of the index table creating process. In step S510, the target measuring module M11 selects the paint of the object and generates the unique paint number of the paint. For example, the paint distributor handles several thousands of kinds of paint, and one of them is selected by the target measuring module M11. In step S520, the target spectral reflectance Rₜ(λ) of the selected paint sample is measured by the spectral reflectometer 48b. Further, the target spectral reflectance Rₜ(λ) is a vector configured of the spectral reflectance R(λ) in each wavelength section (for example, 10 nm partition). In step S530, the ink amount set calculating module M12 calculates an optimized solution for the ink amount set, with which the target spectral reflectance Rₜ is reproducible, using the spectral predicting module M13. Hereinafter, any ink amount set of the CMYKlclm inks is denoted by the vector φ={d_{C}, d_{M}, d_{Y}, d_{K}, d_{1c}, d₁ₘ}. By receiving any ink amount set φ as an input, the spectral predicting module M13 predicts the spectral reflectance (hereinafter, denoted by a predicted spectral reflectance Rₛ(λ)) when the printer 48a performs printing on the glossy paper according to the ink amount set φ. That is, the spectral predicting module M13 receives the ink amount set φ as an input and provides a function PM(φ) for calculating the predicted spectral reflectance Rₛ(λ) by Equation 1 below:

[Equation 1]

Rₛ(λ)=PM(φ)

The ink amount set calculating module M12 calculates the difference D(λ) between the target spectral reflectance Rₜ(λ) and the predicted spectral reflectance Rₛ(λ) with respect to each wavelength λ, and multiplies a weighting function w(λ) imposed with a weight on every wavelength λ by the difference D(λ). A square root of a square mean of the value is calculated as an evaluation value E(φ). When the above calculations are expressed as an equation, it can be expressed as Equation 2 below:

$$\begin{matrix}[ Equation 2 ] & \\ E ( φ ) = \sqrt{\frac{\sum {\{ w ( λ ) D ( λ ) \}}^{2}}{N}} \\ D ( λ ) = {R}_{t} ( λ ) - {R}_{s} ( λ ) & ( 2 )\end{matrix}$$

In Equation 2 described above, N means the number of sections in the wavelength λ. In Equation 2, as the evaluation value E(φ) decreases, the difference between the target spectral reflectance Rₜ(λ) and the predicted spectral reflectance Rₛ(λ) can be reduced in each wavelength λ. That is, as the evaluation value E(φ) decreases, when the printer 48b performs printing on the glossy paper according to the input ink amount set φ, the spectral reflectance R(λ) reproduced on the glossy paper can be approximated to the target spectral reflectance Rₜ(λ) obtained from the sample of the corresponding paint.

In addition, a reproduced color of the printer 48a according to the ink amount set φ and an absolute color represented by the sample of the corresponding paint are changed according to changes in the light source. However, by reducing the evaluation value E(φ), both colors can be relatively matched. Therefore, with the ink amount set φ through which the evaluation value E(φ) decreases, it can be seen that a print result can be obtained in which the paint is equally perceived as representing the color of the paint under any light source.

In this embodiment, the weighting function w(λ) uses Equation 3 below:

[Equation 3]

w(λ)=x(λ)+y(λ)+z(λ) (3)

In Equation 3 described above, the weighting function w(λ) is defined by adding color-matching functions x(λ), y(λ), and z(λ). Further, the range of the value of the weighting function w(λ) may be normalized by multiplying the entire right side of Equation 3 by a predetermined coefficient. The color-matching functions x(λ), y(λ), and z(λ) include spectrums according to the visual sensitivity of human eyes, and it can attach importance to the spectral reflectance R(λ) in a wavelength band in which human eyes are sensitive. For example, w(λ) becomes zero in a near-ultraviolet band which is not perceptible by human eyes, and the difference D(λ) in this wavelength band does not contribute to the increase in the evaluation value E(φ).

That is, even though the difference between the target spectral reflectance Rₜ(λ) and the predicted spectral reflectance Rₛ(λ) in the entire visible wavelength band is not necessarily small, when the target spectral reflectance Rₜ(λ) and the predicted spectral reflectance Rₛ(λ) are approximated to each other in the wavelength band which is strongly perceptible by human eyes, the small evaluation value E(φ) can be obtained. In addition, the evaluation value E(φ) can be used as a standard of the approximation of the spectral reflectance R(λ) based on the perception of human eyes. The ink amount set calculating module M12 makes the spectral predicting module M13 calculate the predicted spectral reflectance Rₛ(λ) each time the ink amount set φ is sequentially shifted, so that the evaluation value E(φ) is calculated. Then, an optimized solution of the ink amount set φ is calculated to minimize the evaluation value E(φ). As a scheme of calculating the optimized solution, various optimization schemes may be used. For example, it is preferable that a nonlinear optimization scheme called a gradient technique is used.

As described above, when the ink amount set φ with which the target spectral reflectance Rₜ(λ) is reproducible in step S530, the table creating module M14 associates the paint number of the sample measured of the target spectral reflectance Rₜ(λ), the target spectral reflectance Rₜ(λ), and the calculated ink amount set φ with one another, and all of which are stored in the index table IDT (step S540). In step S550, it is determined whether or not all the paints are selected. When all the paints are not selected, the procedure returns to step S510, and the next paint is selected. In this way, the paint can be sequentially selected, and thus the ink amount set φ, with which the target spectral reflectance Rₜ(λ) is reproducible, is calculated for each paint to be able to create the index table IDT in which the correspondence relationship between the paint number of each paint and the ink amount set φ is stored. The finally created index table IDT is stored in the HDD 44, and is handled as an object for which access is limited by the usage managing module M12. Further, in this embodiment, printing of the sample sheet SS in an agency store, which has not paid the license fee, is limited due to the access limitation on the index table IDT. However, when printing of the sample sheet SS is limited by other schemes (for example, the limitation in operation of the sample printing module M2), the index table IDT may be stored in the HDD 24 of the agency store.

Further, when the index table IDT is created, information on the paint distributor to be identified is also added to the index table IDT. Hereinbefore, the process of newly creating the index table IDT with respect to all the paints which are manufactured and sold by the paint distributor has been described. However, when there is a request to add paints which are manufactured and sold by the paint distributor, it can responded to by newly adding the paint number, the ink amount set φ, and the index to the existing index table IDT. Of course, regarding paint which is sold out, the paint number, the ink amount set φ, and the index thereof may be removed from the index table IDT. Therefore, even when the lineup of the paint of the paint distributor is changed, it is possible to respond thereto flexibly. Further, when the index table creating process or the addition of the paint is carried out, a module for carrying out a process of charging the cost to the paint distributor may be added. Further, in this embodiment, the sample of the paint is transferred to the printer maker, and the spectral reflectance is measured in the printer maker. However, it is matter of course that the spectral reflectance of the paint is measured by the paint distributor and the resulting data is transmitted to the printer maker, so that it is considered as a request of creating the index table IDT or a request of adding thereto.

As described above, the printer 48a which is the standard machine connected to the computer 10 of the paint distributor and the printer 28a connected to the computer 20 of the agency store are of the same model. When the printers perform printing at the same ink amount set φ, it would be ideal if the printing results could be equal to each other. On the assumption of the ideal, the printer 28a obtains the same reproduction of the spectral reflectance by the index table IDT created on the basis of the reproduction of the spectral reflectance of the printer 48a. However, it is impossible to completely remove individual errors or time degradation from the printer 28a, so that it is necessary to perform calibration processes to remove these errors and to correct the index table IDT.

### F2. Calibration Process

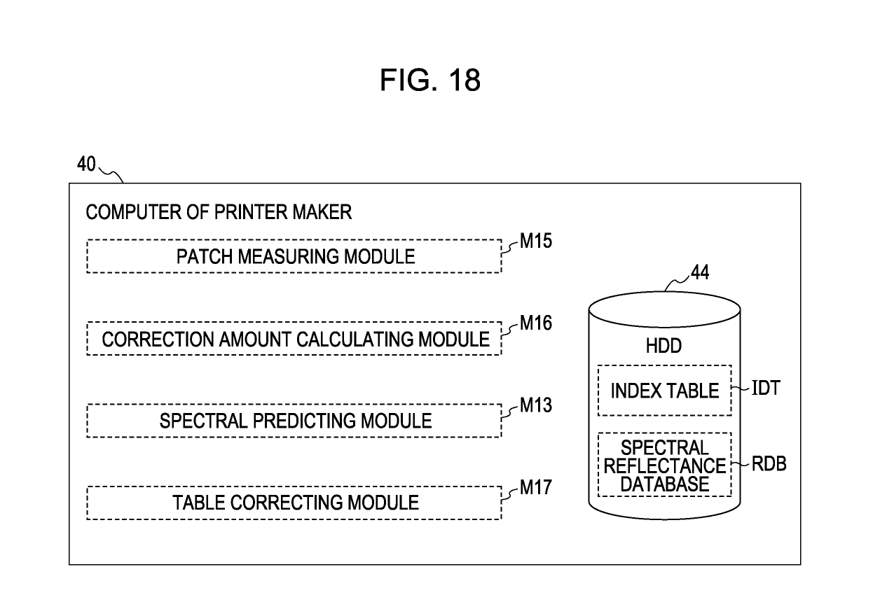

FIG. 18 shows a software configuration of the computer 10 which performs the calibration process. The computer 10 performs the spectral predicting module M13, a patch measuring module M15, a correction amount calculating module M16, and a table correcting module M17 as the software configuration for carrying out the calibration process. The spectral predicting module M13 carries out the same process as the index table creating process. The patch measuring module M15 measures the spectral reflectance (hereinafter, denoted by a correcting spectral reflectance R_{c}(λ)) of a correcting patch using the spectral reflectometer 48b with respect to each paint which is printed by the printer 28a connected to the computer 20 of the agency store. The correction amount calculating module M16 calculates a correction amount of the ink amount set φ on the basis of the target spectral reflectance Rₜ(λ) and the correcting spectral reflectance R_{c}(λ) of each paint. The table correcting module M17 reflects the correction amount calculated by the correction amount calculating module M16 to the index table IDT.

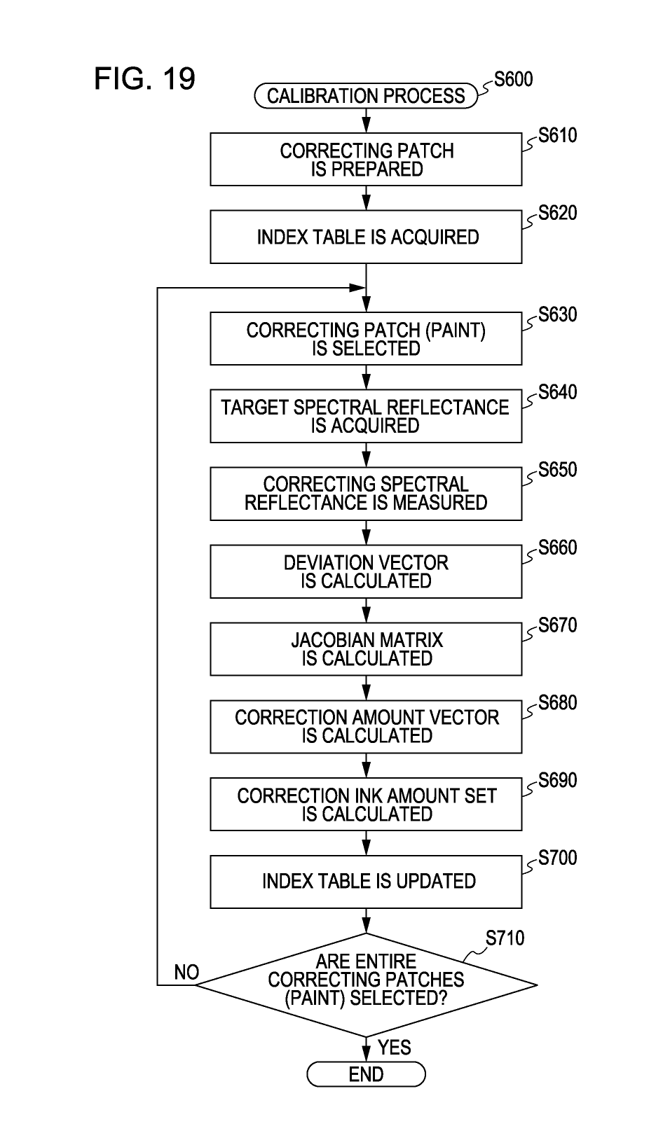

FIG. 19 shows a flow of the calibration process. In step S610, the spectral reflectance R(λ) is measured with respect to plural correcting patches which are printed by the printer 28a connected to the computer 20 of the agency store. Since the characteristics of ink ejection in the printer 28a are changed over time, a color chart is made to be periodically printed in the computer 20 of the agency store and the color chart is transmitted to the paint distributor.

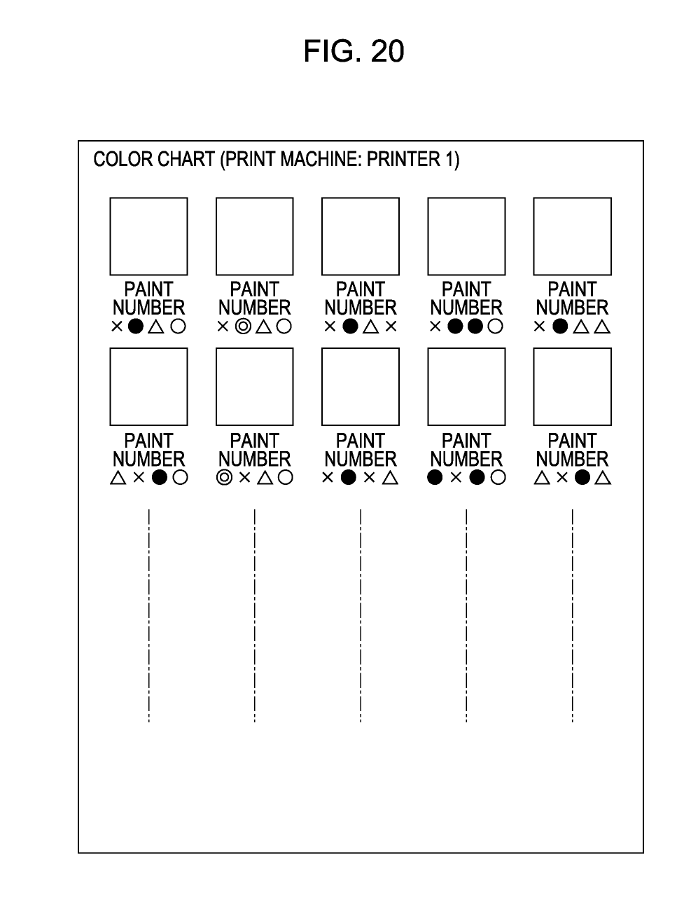

FIG. 20 shows an example of the color chart. In the color chart, a large number of correcting patches in a rectangular shape are arranged in a matrix shape. The correcting patches correspond to the paints respectively, and the paint numbers are printed on a position close to each correcting patch. When plural printers 28a are connected to the computer 20 of the agency store, a machine number is printed to specify any one of them. When the color chart is printed by the computer 20 of the agency store, the print data PD is generated by disposing the pixels, each of which stores the index and the flag corresponding to the paint number in the index table IDT stored in the HDD 24, on the positions corresponding to the correcting patches and printing may be performed on the basis of the print data PD. As a result, similar to the sample region SA of the sample sheet SS, it is possible to print each correcting patch at the ink amount set φ defined in the index table IDT.

In step S620, the index table IDT corresponding to the printer 28a printed on the color chart is acquired from the HDD 44. The ink amount set φ defined in the index table IDT becomes a correction object in the calibration process. In step S630, the patch measuring module M15 selects the correcting patch. In step S640, the input of the paint number of the selected correcting patch is accepted, and the target spectral reflectance Rₜ(λ) associated with the paint number in the index table IDT is acquired. In step S650, the correcting spectral reflectance R_{c}(λ) of the selected correcting patch is measured by the spectral reflectometer 48b. Here, it is ideal if the target spectral reflectance Rₜ(λ) and the correcting spectral reflectance R_{c}(λ) are matched with each other. However, due to the individual errors or the time degradation in the printer 28a, difference between the two occurs.

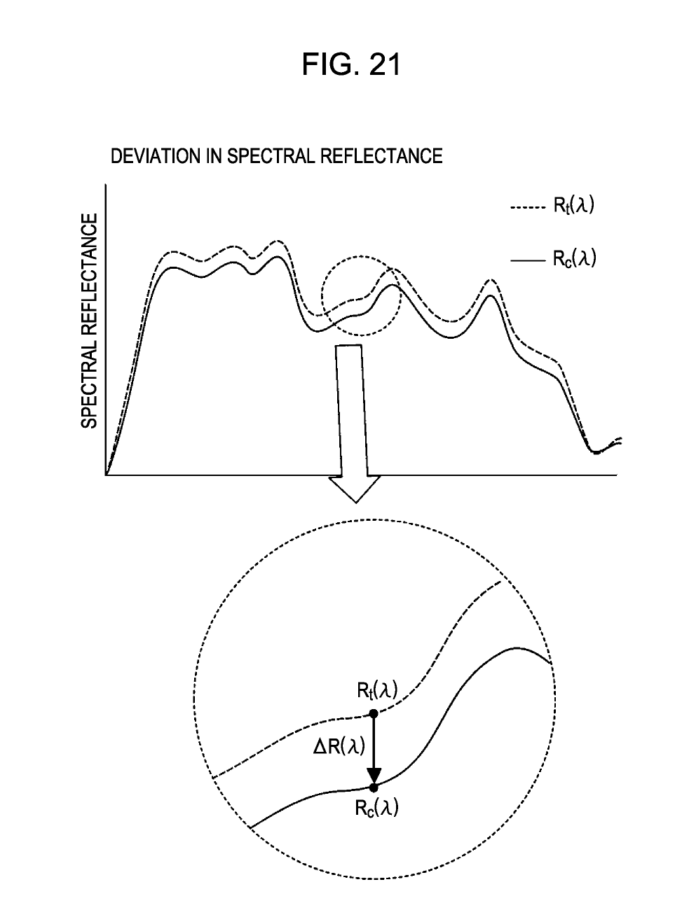

FIG. 21 shows the target spectral reflectance Rₜ(λ) and the correcting spectral reflectance R_{c}(λ) in contrast to each other with respect to a paint (paint number). As shown in the drawing, the correcting spectral reflectance R_{c}(λ) roughly traces the target spectral reflectance Rₜ(λ), but the correcting spectral reflectance R_{c}(λ) is shifted to the lower reflection as a whole. For example, when the ink amount of each ink which is ejected by the printer 28a increases over time, the correcting spectral reflectance R_{c}(λ) is shifted to the lower reflectance as a whole. In step S660, the correction amount calculating module M16 subtracts the target spectral reflectance Rₜ(λ) from the correcting spectral reflectance R_{c}(λ), and thus each deviation AR(λ) is calculated. Further, the deviation ΔR(λ) can be expressed by a deviation vector ΔR in Equation 4 consisting of the deviation ΔR(λ) in each wavelength section as follows:

[Equation 4]

ΔR=(ΔR₃₆₅,ΔR₃₇₅,ΔR₃₈₅. . . ΔR₈₀₅,ΔR₈₁₅,ΔR₈₂₅) (4)

In Equation 4 described above, ΔRₐ shows an average deviation ΔR(λ) between the wavelength sections λ=(a−5)˜(a+5) [nm] (where, “a” is a value of 10 nm period in the visible wavelength band). The correction amount calculating module M16 acquires the ink amount set φ (the ink amount set φ defined in the index table IDT) when the selected correcting patch is printed in step S670, and calculates a Jacobian matrix J of the prediction of spectral reflectance Rₛ(λ) regarding a minute section in the vicinity of the ink amount set φ. When the Jacobian matrix J of the prediction of spectral reflectance Rₛ(λ) is calculated, the spectral predicting module M13 is used which can calculate the prediction of spectral reflectance Rₛ(λ) regarding any ink amount set φ. The Jacobian matrix J can be expressed by Equation 5 below:

$$\begin{matrix}[ Equation 5 ] & \\ J = [ \begin{matrix}\frac{\partial {R}_{s 365}}{\partial {d}_{C}} & \frac{\partial {R}_{s 365}}{\partial {d}_{M}} & \frac{\partial {R}_{s 365}}{\partial {d}_{Y}} & \frac{\partial {R}_{s 365}}{\partial {d}_{K}} & \frac{\partial {R}_{s 365}}{\partial {d}_{lc}} & \frac{\partial {R}_{s 365}}{\partial {d}_{l m}} \\ \frac{\partial {R}_{s 375}}{\partial {d}_{C}} & \frac{\partial {R}_{s 375}}{\partial {d}_{M}} & \frac{\partial {R}_{s 375}}{\partial {d}_{Y}} & \frac{\partial {R}_{s 375}}{\partial {d}_{K}} & \frac{\partial {R}_{s 375}}{\partial {d}_{lc}} & \frac{\partial {R}_{s 375}}{\partial {d}_{l m}} \\ ⋮ & ⋮ & ⋮ & ⋮ & ⋮ & ⋮ \\ \frac{\partial {R}_{s 815}}{\partial {d}_{C}} & \frac{\partial {R}_{s 815}}{\partial {d}_{M}} & \frac{\partial {R}_{s 815}}{\partial {d}_{Y}} & \frac{\partial {R}_{s 815}}{\partial {d}_{K}} & \frac{\partial {R}_{s 815}}{\partial {d}_{lc}} & \frac{\partial {R}_{s 815}}{\partial {d}_{l m}} \\ \frac{\partial {R}_{s 825}}{\partial {d}_{C}} & \frac{\partial {R}_{s 825}}{\partial {d}_{M}} & \frac{\partial {R}_{s 825}}{\partial {d}_{Y}} & \frac{\partial {R}_{s 825}}{\partial {d}_{K}} & \frac{\partial {R}_{s 825}}{\partial {d}_{lc}} & \frac{\partial {R}_{s 825}}{\partial {d}_{l m}}\end{matrix} ] & ( 5 )\end{matrix}$$

In Equation 5 described above, Rₛₐ shows an average prediction of spectral reflectance Rₛ(λ) between the wavelength sections λ=(a−5)˜(a+5) [nm]. The Jacobian matrix J is a matrix in a form of the number of the wavelength sections (rows)×the number of the inks (columns).

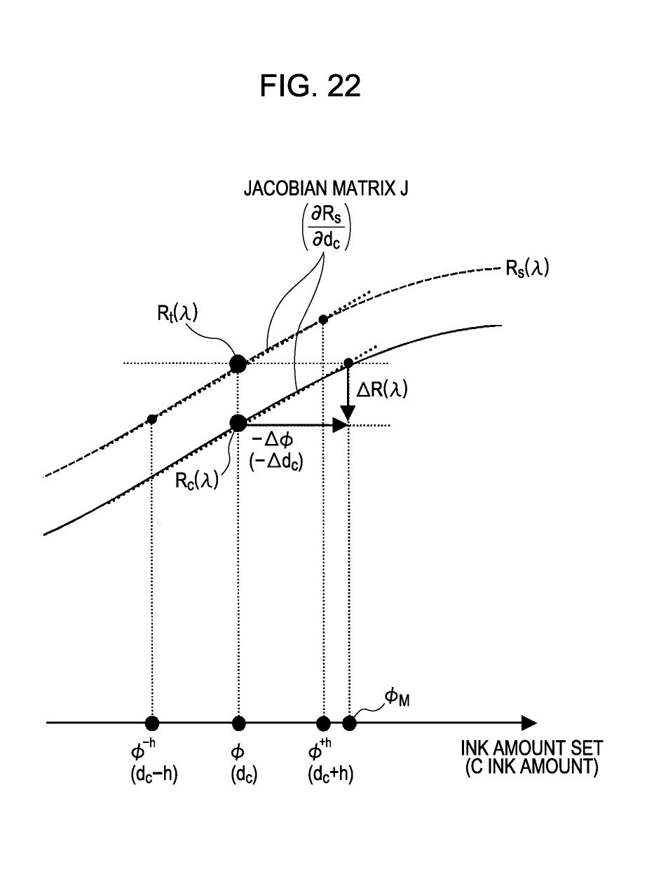

FIG. 22 shows the calculation of the Jacobian matrix J. First, paying attention to the C ink among the ink sets, the ink amounts (d_{c}+h) and (d_{c}−h) are calculated by adding or subtracting a minute amount h with respect to the ink amount d_{c} used when the correcting patch is printed. Then, while other inks remain as the ink amounts (d_{M}, d_{Y}, d_{K}, d_{1c}, d₁ₘ) which are used when the correcting patch is printed, the ink amount set φ^{+h}(d_{C}+h, d_{Y}, d_{K}, d_{1c}, d₁ₘ) and the ink amount set φ^{-h}(d_{C}−h, d_{Y}, d_{K}, d_{1c}, d₁ₘ) are set. Then, the ink amount sets φ^{+h} and φ^{-h} are input to the spectral predicting module M13, so that the predictions of the spectral reflectance Rₛ^{+h}(λ) and Rₛ^{-h}(λ) are calculated (averages of Rₛ₃₆₅, Rₛ₃₇₅, Rₛ₃₈₅, . . . in each wavelength section) by the spectral printing model (Equation 1 above). Here, the difference between the predictions of the spectral reflectance Rₛ^{+h}(λ) and Rₛ^{-h}(λ) can be considered as the variation in the prediction of spectral reflectance Rₛ(λ) corresponding to the minute sections (d_{C}+h) to (d_{C}−h) of the C ink amount. Therefore, if it is assumed that the variation in the prediction of spectral reflectance Rₛ(λ) is linear in the minute sections (d_{C}+h) to (d_{C}−h), a partial differential value regarding the C ink can be obtained by {Rₛ^{+h}(λ)−Rₛ^{-h}(λ)}/2 h. By similarly carrying out the calculation on each wavelength section, one row (C ink components) of the Jacobian matrix J can be obtained. Paying attention to the MYKlclm inks sequentially, the same calculation is carried out, so that it is possible to obtain the Jacobian matrix J in the vicinity of the ink amount set φ when the selected correcting patch is printed.

As described above, when the Jacobian matrix J is obtained, in step S680, the correction amount calculating module M16 calculates the correction amount vector Δφ (Δd_{C}, Δd_{M}, Δd_{Y}, Δd_{K}, Δd_{1c}, Δd₁ₘ) of the ink amount set φ by Equation 6 below:

[Equation 6]

Δφ^{T}=J⁻¹·ΔR^{T} (6)

In Equation 6 described above, J⁻¹ means an inverse matrix of the Jacobian matrix J. When the inverse matrix J⁻¹ is calculated, singular value decomposition is employed which is represented by Equation 7 below:

[Equation 7]

H=U·Σ V^{T} (7)

J⁻¹=V·Σ⁻¹·U^{T}

In Equation 7 described above, the Jacobian matrix J is first decomposed into matrixes U, Σ, and V^{T}, so that the inverse matrix (pseudo inverse matrix) J⁻¹ can be calculated. Further, the Jacobian matrix J is a matrix in a form of a non-rectangular shape of the number of the wavelength sections (rows) x the number of the inks (columns). However, through the singular value decomposition, the Jacobian matrix J is decomposed into the matrix U of the number of the wavelength sections (rows)×the number of the wavelength sections (columns), the matrix V^{T} of the number of the inks (rows)×the number of the inks (columns), and the matrix Σ which is in a form of the number of the wavelength sections (rows)×the number of the inks (columns) and components other than the diagonal components become zero. In addition, the inverse matrix Σ⁻¹ of the matrix Σ can be obtained by taking reciprocal numbers with respect to the diagonal components of the matrix Σ. In addition, for convenience of processing, when the reciprocal number is smaller than a predetermined threshold value, it is preferable that the reciprocal number is treated as zero.

As described above, when the correction amount vector Δφ of the ink amount set φ is calculated, the correction amount calculating module M16 subtracts the correction amount vector Δφ from the original ink amount set φ used in printing the correcting patch by Equation 8 described below, so that the correction ink amount set φ_{M} is calculated in step S690.

[Equation 8]

φ_{M}=φ−Δφ (8)

When the correction ink amount set φ_{M} is calculated, the table correcting module M17 updates the ink amount set φ associated with the paint (paint number), which is currently selected in the index table IDT, by the correction ink amount set φ_{M} in step S700. In step S710, it is determined whether or not all the paints (paint numbers) are selected. When not all paints are selected, the procedure returns to step S610, and a process of correcting the ink amount set φ is performed on the next paint. When all the paints are selected, the index table IDT, in which the entire components of the ink amount set φ are updated by the correction ink amount set φ_{M}, can be accessed from the computer 20 of the agency store. Therefore, it is possible to print the sample sheet SS in the computer 20 of the agency store using the corrected index table IDT. Since the index table IDT is effective only in the printer 28a which prints the color chart, the index table IDT is associated with the machine number which is printed on the color chart. As a result, it is possible to refer to the index table IDT corresponding to the printer which is designated to actually print the sample sheet SS. Further, when the calibration process is performed, a module for performing a process of charging a cost to the paint distributor may be added.

In the sample sheet SS printed on the basis of the correction ink amount set φ_{M}, printing can be realized to supplement the deviation ΔR(λ) described above. In addition, the target spectral reflectance Rₜ(λ) can be reproduced with high accuracy. In the following, the principle will be described with reference to FIG. 21. The slope characteristics of the prediction of spectral reflectance Rₛ(λ) by the spectral printing model in the vicinity of the ink amount set φ of the correction object, which is used when each correcting patch is printed, can be considered to be similar to the slope characteristics of the correcting spectral reflectance R_{c}(λ) obtained by actually measuring the correcting patch. This is because the absolute value of the actually printed correcting spectral reflectance R_{c}(λ) is shifted due to time degradation or an individual error of the printer 28a in most cases, but the relative variability characteristics between the ink amount sets φ which are approximated to each other is not largely changed. In addition, it can be assumed that the change in the minute section is linear. [00112] As shown in FIG. 22, the correction ink amount set φ_{M} with which the target spectral reflectance Rₜ(λ) is actually reproducible becomes the value which represents the target spectral reflectance Rₜ(λ) of the curve (which is illustrated with a solid line) which passes through the correcting spectral reflectance R_{c}(λ) However, since the correcting spectral reflectance R_{c}(λ) is obtained only on the ink amount set φ of the correction object which is used when each correcting patch is printed, the correcting spectral reflectance R_{c}(λ) is not obtained for any ink amount set φ. Therefore, it is impossible to directly calculate the correction ink amount set φ_{M}, with which the target spectral reflectance Rₜ(λ) is actually reproducible, on the basis of the correcting spectral reflectance R_{c}(λ). For this reason, the curve (which is illustrated with a broken line) of the prediction of spectral reflectance Rₛ(λ) is first obtained on the basis of the spectral printing model which can obtain the prediction of spectral reflectance Rₛ(λ) with respect to any ink amount set φ. Then, the Jacobian matrix J representing the slope in the vicinity of the ink amount set φ of the correction object, which is used when the correcting patch is printed, is calculated in the curve.

As described above, in the curve of the actual correcting spectral reflectance R_{c}(λ) which is illustrated with a broken line and the curve of the prediction of spectral reflectance Rₛ(λ) based on the spectral printing model, the absolute values are shifted, but the relative variability characteristics can be considered to be similar to each other. Therefore, the curve of the actual correcting spectral reflectance R_{c}(λ) can be also estimated as having the same slope. If the slope of the actual correcting spectral reflectance R_{c}(λ) is estimated in this way, it can be considered that a linear relationship shown in Equation 6 is satisfied among the deviation ΔR(λ), the correction amount vector Δφ necessary to supplement the deviation ΔR(λ), and the Jacobian matrix J representing the slope. Then, by solving Equation 6 regarding the correction amount vector Δφ to subtract the correction amount vector Δφ from the original ink amount set φ, it is possible to obtain the correction ink amount set 100 _{M} with which the target spectral reflectance Rₜ(λ) is actually reproducible. Further, the Jacobian matrix J is configured of the row components for each plural wavelength section. However, by solving Equations 6 and 7, it is possible to obtain the correction ink amount set Δ_{M} with which the deviation ΔR(λ) of each wavelength is decreased just like the least-square method. Hereinbefore, the technical idea of the invention is described by the calculation carried out by the determinant, but the calculations equivalent to Equations 5 to 8 may be carried out. In addition, the Jacobian matrix J is not necessarily limited to Equation 5, but the calculations equivalent to Equations 6 to 8 may be carried out by using an equation or a matrix equivalent to the Jacobian matrix J.

### G. Spectral Printing Model

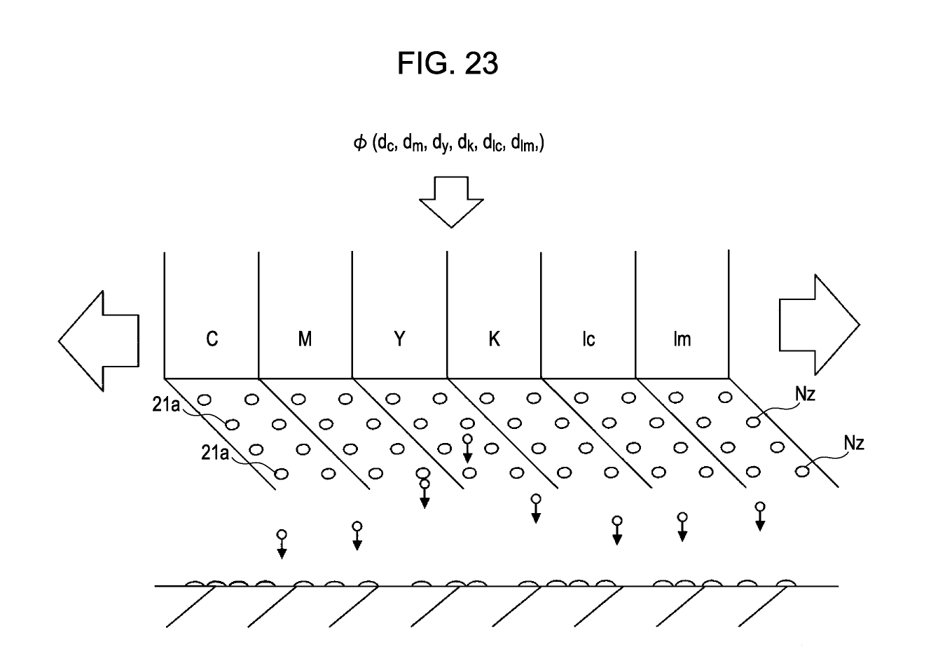

FIG. 23 schematically shows the printing scheme of the printer 28a (48a) according to this embodiment. The printer 28a is provided with a print head HD which is provided with plural nozzles NZ, NZ, . . . in every CMYKlclm ink. The printer is controlled such that the ink amounts of the CMYKlclm inks ejected by the nozzles NZ, NZ, . . . become amounts designated by the above-mentioned ink amount set φ (d_{c}, dₘ, d_{y}, dₖ, d_{1c}, d₁ₘ) on the basis of the print data PD. Ink droplets ejected by the respective nozzles NZ, NZ, . . . become minute dots on the print paper, and a large number of dots are collected to form the print image with ink area coverage according to the ink amount set φ (d_{c}, dₘ, d_{y}, dₖ, d_{1c}, d₁ₘ) on the print paper.

A prediction model (spectral printing model) used by the spectral predicting module M13 is a prediction model for predicting the spectral reflectance R(λ) by the prediction of spectral reflectance Rₛ(λ) when printing is carried out at any ink amount set φ (d_{c}, dₘ, d_{y}, dₖ, d_{1c}, d₁ₘ) which can be used in the printer 28a according to this embodiment. The prediction model corresponds to the function PM(φ) of Equation 1. In the spectral printing model, the spectral reflectance database RDB is prepared which is obtained by printing the color patch by the standard machine (printer 48a) as to plural representative points in the ink amount space and by measuring the spectral reflectance R(λ) thereof by the spectral reflectometer. Then, the prediction is carried out by the cellular Yule-Nielsen Spectral Neugebauer Model in which the spectral reflectance database RDB is used, so that the spectral reflectance R(λ) is predicted when printing is accurately carried out at any ink amount set φ (d_{c}, dₘ, d_{y}, dₖ, d_{1c}, d₁ₘ).

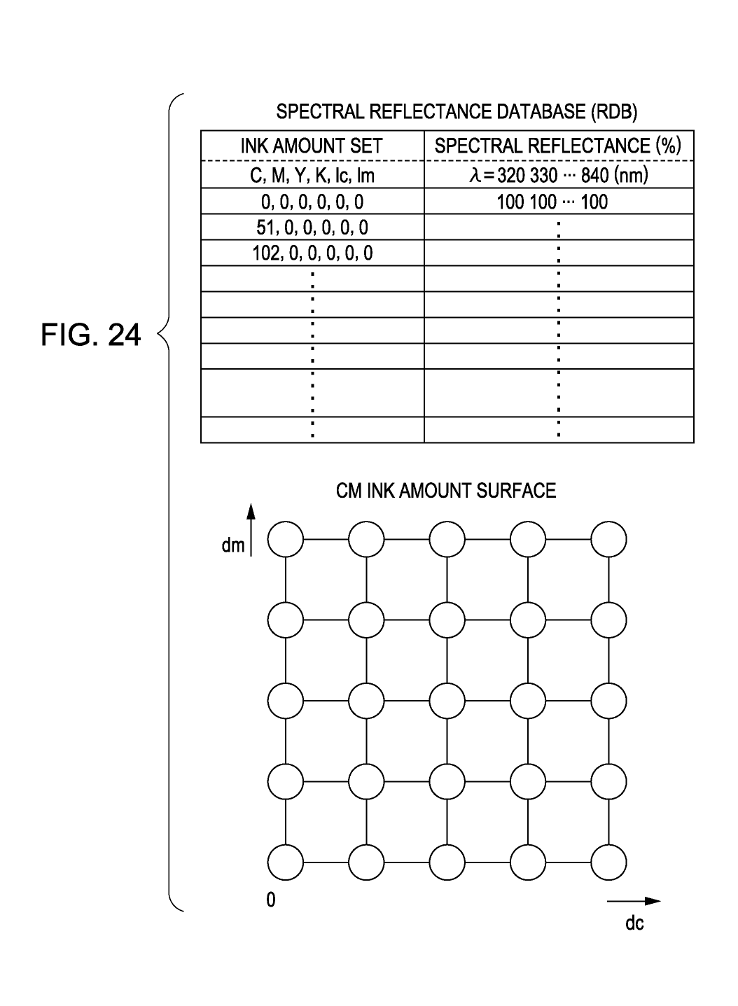

FIG. 24 shows the spectral reflectance database RDB. As shown in the drawing, the spectral reflectance database RDB is a lookup table in which the spectral reflectance R(λ) is stored. The spectral reflectance R(λ) is obtained by actually performing printing and measuring on the ink amount set φ (d_{c}, dₘ, d_{y}, dₖ, d_{1c}, d₁ₘ) of plural grid points in the ink amount space (six dimensions in this embodiment, but only the CM surface is illustrated for simplification of the drawing). For example, 5 grid points dividing each ink amount axis are generated. Here, 5¹³ grid points are generated, and a vast amount of the color patches are necessarily printed and measured. However, since the printer 28a actually has limitations on the number of the inks capable of being mounted at the same time or the control of the ink duty capable of ejecting at the same time, the number of the grid points used in printing and measuring is reduced.

In addition, only a part of the grid points is used for printing and measuring, and the spectral reflectance R(λ) of the other grid points is predicted on the basis of the spectral reflectance R(λ) of the grid points which are actually used to perform printing and measuring, so that the number of the color patches on which printing and measuring are actually performed may be reduced. The spectral reflectance database RDB is necessary to prepare for every print paper with which the printer 28a can perform printing. Strictly speaking, this is because the spectral reflectance R(λ) is determined by the spectral transmittance and the reflectance of the print paper which are caused by an ink film (dot) formed on the print paper, and is strongly influenced by the surface property (the dot shape depends thereon) or the reflectance of the print paper. Next, the prediction by the cellular Yule-Nielsen Spectral Neugebauer Model in which the spectral reflectance database RDB is used will be described. [00118] The spectral predicting module M13 performs the prediction by the cellular Yule-Nielsen Spectral Neugebauer Model in which the spectral reflectance database RDB is used. In this prediction, the print paper (the glossy paper in this embodiment) and the ink amount set φ are set as the print conditions. When the prediction is carried out on the glossy paper as the print paper, the spectral reflectance database RDB which is created by printing the color patch on the glossy paper is set.

When the setting of the spectral reflectance database RDB is complete, the ink amount set φ (d_{c}, dₘ, d_{y}, dₖ, d_{1c}, d₁ₘ) output from the ink amount set calculating module M12 or the correction amount calculating module M16 is applied to the spectral printing model. The cellular Yule-Nielsen Spectral Neugebauer Model is based on the spectral Neugebauer model and the Yule-Nielsen model, which are well known. Further, in the following description, for simple description, a model in which 3 kinds of inks of CMY are used will be described. The same model is easily extended to a model using any ink amount set including the CMYKlclm according to this embodiment. In addition, as to the cellular Yule-Nielsen Spectral Neugebauer Model, Color Res Appl 25, 4-19, 2000 and R Balasubramanian, Optimization of the spectral Neugebauer model for printer characterization, J. Electronic Imaging 8(2), 156-166(1999) are cited.

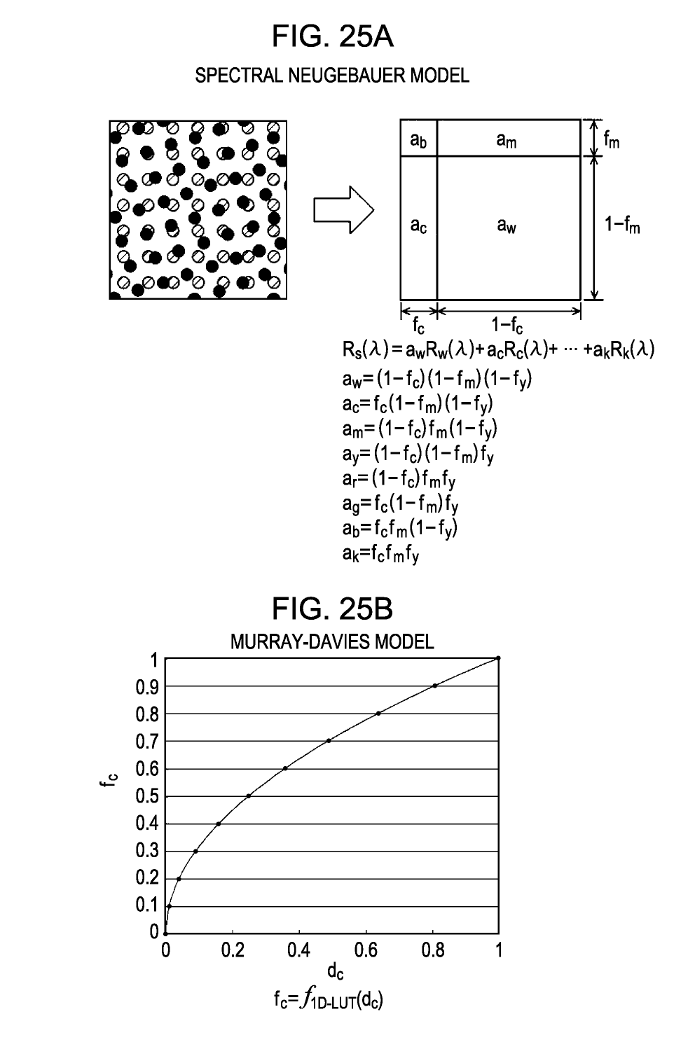

FIG. 25A is a view illustrating the spectral Neugebauer model. In the spectral Neugebauer model, the prediction of spectral reflectance Rₛ(λ) when printing is performed at any ink amount set (d_{c}, dₘ, d_{y}) is given by Equation 9 below:

[Equation 9]

Rₛ(λ)=a_{w}R_{w}(λ)+a_{c}R_{c}(λ)+aₘRₘ(λ)+a_{y}R_{y}(λ)+aᵣRᵣ(λ)+a_{g}R_{g}(λ)+a_{b}R_{b}(λ)+aₖRₖ(λ) (9)

a_{w}=(1−f_{c})(1−fₘ(1f_{y})

a_{c}=f_{c}(1−fₘ(1−f_{y})

aₘ=(1−f_{c}(fₘ(1−f_{y})

a_{y}=(1−f_{c})(1−fₘ)f_{y}

aᵣ=(1−f_{c})fₘf_{y}

a_{g}=f_{c}(1−fₘ)f_{y}

a_{b}=f_{c}fₘ(1−f_{y})

aₖ=f_{c}fₘf_{y}

Here, aᵢ is an area ratio of the i-th region, and Rᵢ(λ) is the spectral reflectance of the i-th region. The suffix “i” means a region (w) of no ink, a region (c) of the cyan ink only, a region (m) of the magenta ink only, a region (y) of the yellow ink only, a region (r) on which the magenta ink and the yellow ink are ejected, a region (g) on which the yellow ink and the cyan ink are ejected, a region (b) on which the cyan ink and the magenta ink are ejected, and a region (λ) on which 3 colors of the CMY inks are ejected. In addition, f_{c}, fₘ, and f_{y} are the proportions of the areas (called as “ink area coverage”), and each of which is covered with the ink when only one kind of the CMY inks is ejected.

The ink area coverage f_{c}, fₘ, and f_{y} are given by the Murray-Davies model shown in FIG. 25B. In the Murray-Davies model, for example, the ink area coverage f_{c} of the cyan ink is a nonlinear function of the ink amount d_{c} of the cyan ink. For example, the ink amount d_{c} can be converted into the ink area coverage f_{c} by a one-dimensional lookup table. The reason that ink area coverage f_{c}, fₘ, and f_{y} are the nonlinear function of the ink amounts d_{c}, dₘ, and d_{y} is that when a small amount of ink is ejected onto a unit area, the ink spreads sufficiently, whereas when a large amount of ink is ejected, the inks overlap with each other so that there is not much increase in the covered area. The other kinds of the MY inks are also the same.

When the Yule-Nielsen model is applied in relation to the spectral reflectance, Equation 9 described above is rewritten as Equation 10a or Equation 10b below:

[Equation 10]

Rₛ(λ)^{1/n}=a_{w}R_{w}(λ)^{1/n}+a_{c}R_{c}(λ)^{1/n}+aₘRₘ(λ)^{1/n}+a_{y}R_{y}(λ)^{1/n} +aᵣRᵣ(λ)^{1/n}+a_{g}R_{g}(λ)^{1/n}+a_{b}R_{b}(λ)hu 1/n+aₖRₖ(λ)^{1/n} (10a)

Rₛ(λ)={a_{w}R_{w}(λ)^{1/n}+a_{c}R_{c}(λ)^{1/n}+aₘRₘ(λ^{1/n}+a_{y}R_{y}(λ)^{1/n}+1ᵣRᵣ(λ)^{1/n}+a_{g}R_{g}(λ)^{1/n}+a_{b}R_{b}(λ)^{1/n}+aₖRₖ(λ)^{1/n}}ⁿ (10b)

Here, n is a predetermined coefficient equal to 1 or more, and for example, n can be set to 10. Equation 10a and Equation 10b are equations representing the cellular Yule-Nielsen Spectral Neugebauer Model.

The cellular Yule-Nielsen Spectral Neugebauer Model employed in this embodiment is obtained by dividing the ink color space of the Yule-Nielsen Spectral Neugebauer Model described above into plural cells.

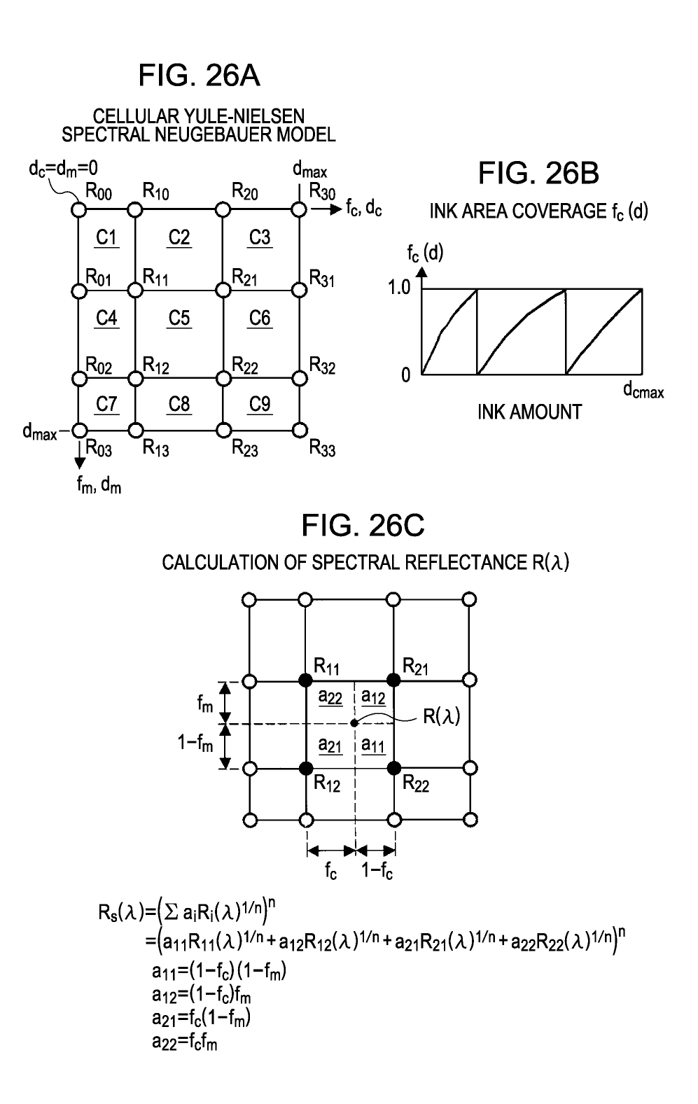

FIG. 26A shows an example of cell division in the cellular Yule-Nielsen Spectral Neugebauer Model. Here, for simple description, the cell division is illustrated in a two-dimensional ink amount space including two axes of the ink amount d_{c} and dₘ of the CM inks. Further, since the ink area coverage f_{C} and fₘ uniquely relate to the ink amount d_{c} and dₘ in the Murray-Davies model described above, the ink area coverage f_{c} and fₘ may be considered as the axes representing the ink area coverage f_{c} and fₘ. The white circles are the grid points (called as “lattice points”) in the cell division. The two-dimensional ink amount (coverage) space is divided into nine cells C1 to C9. The ink amount set (d_{c}, dₘ) corresponding to each lattice point is the ink amount set corresponding to the lattice point defined in the spectral reflectance database RDB. That is, by referring to the spectral reflectance database RDB described above, the spectral reflectance R(λ) of each lattice point can be obtained. Therefore, the spectral reflectance R(λ)₀₀, R(λ)₁₀, R(λ)₂₀, . . . R(λ)₃₃ of each lattice point can be acquired from the spectral reflectance database RDB.

In practice, the cell division in this embodiment also is carried out in the six-dimensional ink amount space of the CMYKlclm inks, and the coordinates of each lattice point also are expressed by the six-dimensional ink amount set φ (d_{c}, dₘ, d_{y}, dₖ, d_{1c}, d₁ₘ) Then, the spectral reflectance R(λ) of each lattice point corresponding to the ink amount set φ (d_{c}, dₘ, d_{y}, dₖ, d_{1c}, d₁m) of each lattice point is acquired from the spectral reflectance database RDB (for example, the spectral reflectance database of the glossy paper).

FIG. 26B shows a relationship between the ink area coverage f_{c} and the ink amount d_{c}, which are used in the cell division model. Here, the ink amount range 0 to d_{cmax} of one kind of ink is also divided into three sections, and the virtual ink area coverage f_{c} used in the cell division model is obtained by the nonlinear curve which increases monotonically from 0 to 1 in every section. The ink area coverage fₘ and f_{y} are also obtained in the same manner.

FIG. 26C shows a calculation method of the prediction of spectral reflectance Rₛ(λ) when printing is performed at any ink amount set (d_{c}, dₘ) in a cell C5 located at the center position shown in FIG. 26A. When printing is performed at the ink amount set (d_{c}, dₘ), the spectral reflectance R(λ) is given by Equation 11 below:

$$\begin{matrix}[ Equation 11 ] & \\ \begin{matrix}{R}_{s} ( λ ) = {( \sum {a}_{i} {{R}_{i} ( λ )}^{1 / n} )}^{n} \\ = {( \begin{matrix}{a}_{11} {{R}_{11} ( λ )}^{1 / n} + {a}_{12} {{R}_{12} ( λ )}^{1 / n} + \\ {a}_{21} {{R}_{21} ( λ )}^{1 / n} + {a}_{22} {{R}_{22} ( λ )}^{1 / n}\end{matrix} )}^{n}\end{matrix} \\ {a}_{11} = ( 1 - {f}_{c} ) ( 1 - {f}_{m} ) \\ {a}_{12} = ( 1 - {f}_{c} ) {f}_{m} \\ {a}_{21} = {f}_{c} ( 1 - {f}_{m} ) \\ {a}_{22} = {f}_{c} {f}_{m} & ( 11 )\end{matrix}$$

Here, in Equation 11, the ink area coverage f_{c} and fₘ are values given by the graph shown in FIG. 26B. In addition, the spectral reflectance R(λ)₁₁, (λ)₁₂, (λ)₂₁, and (λ)₂₂ corresponding to four lattice points surrounding the cell C5 can be acquired by referring to the spectral reflectance database RDB. Therefore, all the values constituting the right side of Equation 11 can be confirmed, and as the calculation result, when printing is performed at any ink amount set φ (d_{c}, dₘ), the prediction of spectral reflectance Rₛ(λ) can be calculated. The wavelength λ is sequentially shifted in the visible wavelength band, so that the prediction of spectral reflectance Rₛ(λ) can be obtained in the visible wavelength band. When the ink amount space is divided into plural cells, the prediction of spectral reflectance Rₛ(λ) can be calculated with high accuracy compared with the case of no division. As described above, the spectral predicting module M13 can predict the prediction of spectral reflectance Rₛ(λ) according to the request of the ink amount set calculating module M12 or the correction amount calculating module M16.

### H. MODIFIED EXAMPLE

### H1. First Modified Example

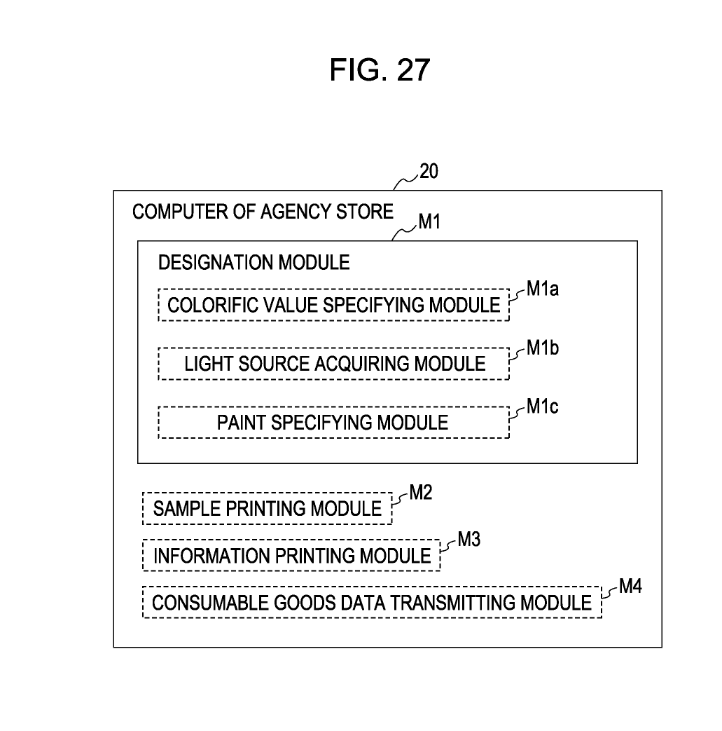

FIG. 27 shows a configuration of the designation module M1 according to this modified example. In this modified example, the designation module M1 is configured to include the colorific value specifying module M1a, the light source acquiring module M1b, and the paint specifying module M1c. In this modified example, the designation of the paint is indirectly accepted from the paint purchaser by performing a process to be described below instead of step S110 in the embodiment described above.

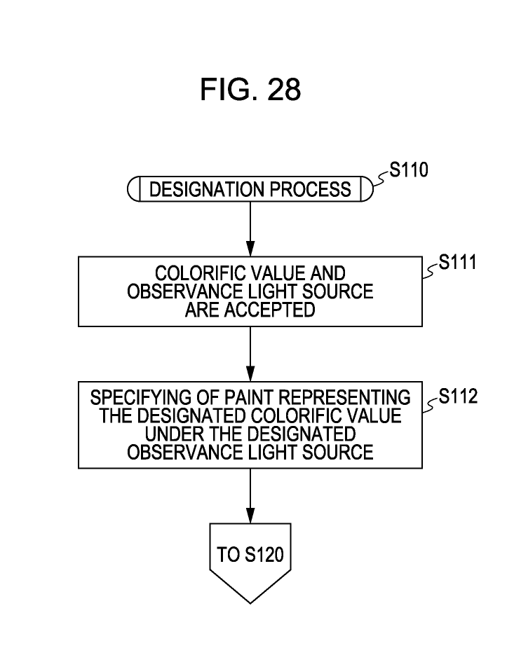

FIG. 28 shows a flow of the designation process which is performed instead of step S110 in the embodiment described above. In step S111, the colorific value specifying module M1a and the light source acquiring module M1b display the UI image to accept the designation of the colorific value and the observance light source from the paint purchaser. Here, the designation of the colorific value in the absolute color space is accepted. For example, the designation of the colorific value is accepted from the paint purchaser, which corresponds to the coordinate values in the CIELAB color space or the XYZ color space. In this embodiment, it is assumed that the designation of the colorific value is accepted which corresponds to the XYZ values (tristimulus values) in the XYZ color space. In addition, the observance light source is a light source under the circumstances of the existing object to be coated with the paint by the paint purchaser, and in this embodiment it can be designated to be the exterior or the interior.

The paint specifying module M1c specifies the XYZ values designated in step S111, and the paint to be realized under the designated observance light source (step S112). Since the target spectral reflectance Rₜ(λ)obtained by measuring each paint is stored in the index table IDT shown in FIG. 9, it is possible to specify which paint has the designated colorific value under the designated observance light source. Further, since the access limitation on the index table IDT is also carried out at this point of time, the paint is specified to the paint distributor who paid the license fee. Specifically, the XYZ values represented by any target spectral reflectance Rₜ(λ) can be calculated by Equation 12 below:

[Equation 12]

X=k∫P(λ)Rₜ(λ)x(λ)dλ

Y=k∫P(λ)Rₜ(λ)y(λ)dλ

Z=k∫P(λ)Rₜ(λ)z(λ)dλ (12)

Equation 12, P(λ) denotes the spectral energy of the designated observance light source, and k denotes a coefficient for normalization. As the spectral energy P(λ) at the exterior, the D65 light source may be used, for example. On the other hand, as the spectral energy P(λ) at the interior, the F11 light source such as a fluorescent lamp may be used, for example. The spectral energy P(λ) of the D65 light source and the F11 light source has a quite different spectrum, and the calculated XYZ values are also different from each other. Further, in this embodiment, the interior is treated with the F₁₁ light source. Furthermore, a lamp light source (an A light source, etc.) may be designated in detail.

In addition, the spectral energy P(λ) of the D65 light source and the F11 light source is also known as standardized data, so that the spectral energy P(λ) can be previously stored in the HDD 24 and can be used by the paint specifying module M1c reading therefrom. The paint specifying module M1c carries out the calculation of Equation 12 on the target spectral reflectance Rₜ(λ) of each paint defined in the index table IDT and the designated spectral energy P(λ), and calculates the XYZ values for each paint. Then, the paint specifying module M1c specifies a paint of which the values calculated by Equation 12 most approximate to the XYZ values designated by the paint purchaser. For example, it is possible to determine whether or not the calculated values are most approximate to the XYZ values designated by the paint purchaser using a Euclidean distance in the XYZ color space. As a result, it is possible to obtain the paint representing the most approximated color to the XYZ values which are designated by the paint purchaser in the observance light source designated by the paint purchaser.

When the desired paint of the paint purchaser is specified, the procedure may proceed after step S120 of the sample sheet printing process of the above-mentioned embodiment. As a result, it is possible to print the sample sheet SS which has the sample region SA with the spectral reflectance characteristics approximated to the paint which the paint purchaser has designated using the colorific value. By this, for example, the invention can be performed on the agency store in which the paint samples are disposed. However, it is preferable that the paint purchaser can recognize the color which is desired by the paint purchaser using the colorific value, but it may be expected that it is difficult to designate the paint because it is generally not familiar with the colorific value. Here, the next modified example discloses a method of further easily designating the colorific value.

### H2. Second Modified Example

In the previous modified example, the colorific value is directly designated. However, it may be configured such that a calorimeter as the image input apparatus of the invention is connected to the computer 20 of the agency store to use the colorimetric value obtained by the calorimeter as the colorific value of the modified example described above. For example, the color of the object taken back from the paint purchaser's own house is measured to specify the paint which is used to print the sample sheet SS on the basis of the colorimetric value. Basically, the colorific value acquired by the colorific value specifying module M1a of the previous modified example may be replaced with the colorimetric value. In this case, it may also be considered that the favorite colored object which the paint purchaser takes back from own house is changed into a different color under the light source in the agency store. Furthermore, after measuring the color under the light source different from the light source under which the paint purchaser observes the object in his or her own house, a sample sheet SS having an unintended color is printed. For this reason, it is preferable that the kind of the light source under which the paint purchaser observes the object be designated and the color measurement be performed under the designated light source. The scanner may be used instead of the calorimeter. In this case, it is preferable that the calibration is performed on the scanner. Further, the spectral reflectometer may be provided in the computer 20 of the agency store. In this case, it is sufficient that the paint of which the spectral reflectance is similar is specified, and there is no need to consider the difference in the light source.

### H3. Third Modified Example

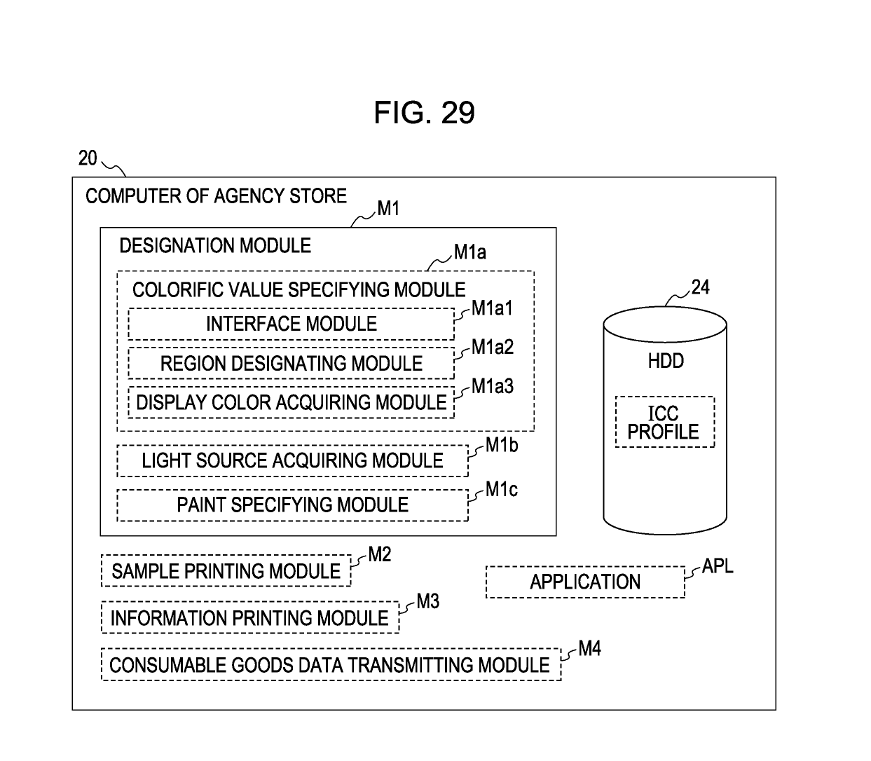

FIG. 29 shows a configuration of the designation module M1 according to this modified example. Also in this modified example, the designation module M1 is configured to include a colorific value specifying module M1a, a light source acquiring module M1b, and a paint specifying module M1c. In this case, the colorific value specifying module M1a is configured to further include an interface module M1a1, a region designating module M1a2, and a display color acquiring module M1a3.

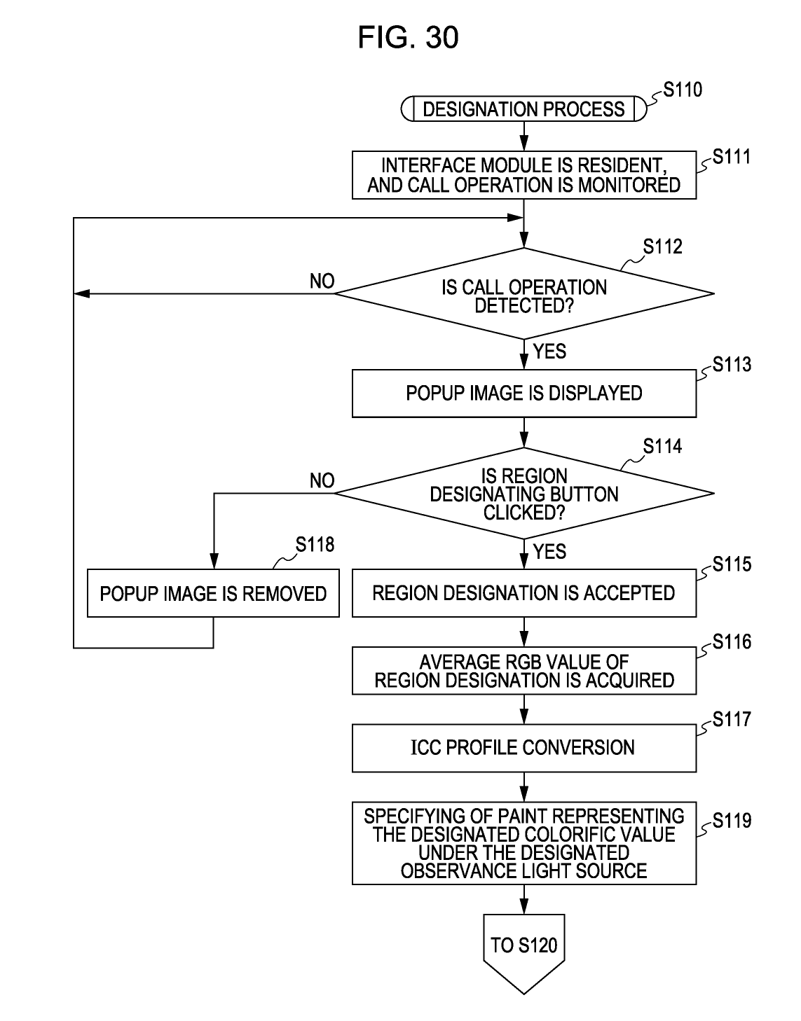

FIG. 30 shows a flow of the designation process performed instead of step S110 in the above-mentioned embodiment. In step S111, the interface module M1a1 starts. The interface module M1a1 is a resident module, and starts when an OS (not shown) starts on the computer 20, and then runs continuously. The OS is a multitasking OS. Even when the application APL shown in FIG. 28 is starting, the interface module M1a1 runs in the background. The interface module M1a1 monitors a predetermined operation (hereinafter, denoted as a call operation) of the input device I/F 27 or the keyboard 27a when other applications APL are running.

For example, when a browser is running as the application APL, it is monitored that the call operation is accepted from the keyboard 27a. For example, it is monitored that a single or plural keys of the keyboard 27a are pressed. In addition, icons are displayed on a part of the display 26a and it may be monitored that the icons are clicked by the mouse 27b. In step S112, it is determined whether or not the call operation is detected. When the call operation is detected, the interface module M1a1 prompts the region designating module M1a2 to start in step S113. Then, the region designating module M1a2 displays a popup image on the display 26a to designate the region.

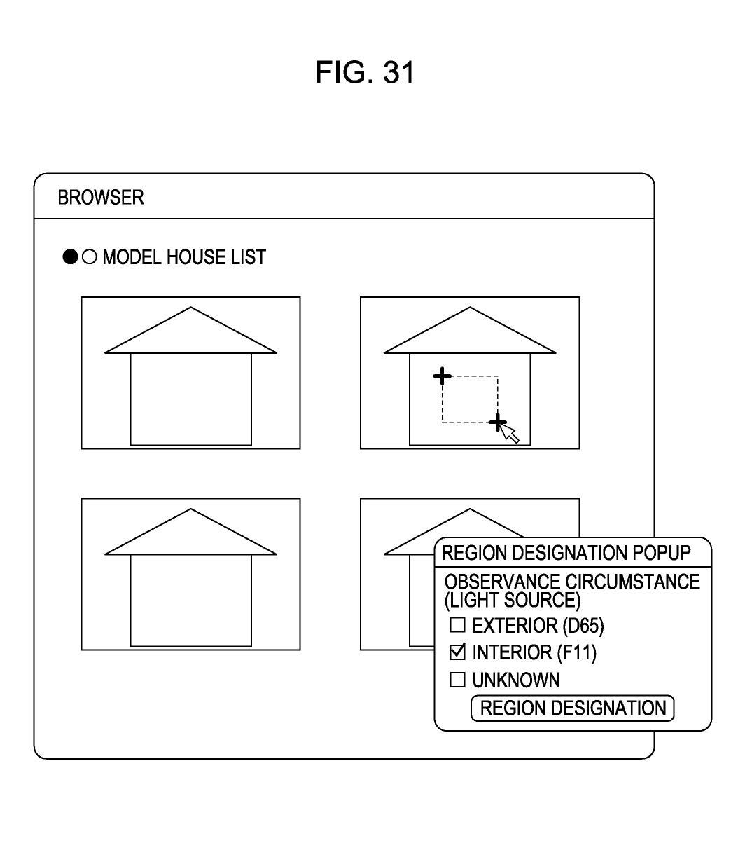

FIG. 31 shows an example of the popup image. In this drawing, the browser as the application APL browses the WEB pages (data which can be rendered by the browser) which are uploaded on the Internet INT. In the WEB pages, image data is included, and images displayed by the image data are displayed on the display 26a by the browser. The popup image is displayed to be overlapped with the image displayed by the browser. In the popup image, there are provided with a region designating button, a cancel button, and check boxes which are used to designate whether the observation light source is the exterior or the interior. In step S114, it is determined whether or not the region designating button is clicked by the mouse 27b. At the same time, the observation light source designated in the popup image is acquired.

When it is determined that the region designating button is clicked, the region designating module M1a2 accepts the designation of the region on the display 26a by a function of drag-and-drop carried by the mouse 27b in step S115. In FIG. 31, a region is shown as an example, which is designated by the function of drag-and-drop from an upper left corner to a lower right corner in a rectangular shape. Of course, the designated region is not limited to the rectangular shape, but a circle or an ellipsoid shape may be employed as well as various kinds of diagrams. In the example shown in FIG. 31, the image is displayed by the browser, and the region can be designated in the image. In addition, the display 26a corresponds to an image output apparatus according to the invention.

In step S116, the display color acquiring module M1a3 acquires an average color displayed in the region which is designated on the display 26a. The display image data output on the display 26a is accumulated in buffers of the RAM 22 or the VRAM of the video I/F 26. The average color displayed in the region which is designated on the display 26a is acquired on the basis of the display image data. In this embodiment, each pixel of the display image data accumulated in the buffers is expressed as the RGB values in the sRGB color space. The display color acquiring module M1a3 extracts the pixel corresponding to the designated region from the display image data, and takes an average of the RGB values, and thus the average color displayed in the designated region is acquired.

The average value of the RGB values means a constant value in the sRGB color space, but is not limited to the color matched with the color actually displayed on the display 26a (the color viewed by the paint purchaser). This is because the display 26a has a unique color reproduction gamut different from the gamut of the sRGB color space. Therefore, when a mapping is performed between these gamuts, image correction may be performed according to the display characteristics of the display 26a. For this reason, the display color acquiring module M1a3 acquires an (output) ICC profile of the display 26a in step S117, and specifies the color actually displayed on the display 26a on the basis of the ICC profile. The ICC profile is a profile which defines a correspondence relationship between the RGB value input in the display 26a and the color actually displayed on the display 26a, and is stored on the HDD 24 in advance.

For example, when the program performing the sample sheet printing process is installed, the corresponding ICC profile may be downloaded from the Internet INT by designating the model of the display 26a to be used. In this embodiment, the color which is actually displayed on the basis of the average value of the RGB value in the designated region is acquired as XYZ values on the basis of the ICC profile. Then, it is also conceivable that the display characteristics of the display 26a are excessively deviated from the ICC profile due to the individual error or the time degradation in the display 26a. In this case, the color deviated from the color which is designated by the paint purchaser after actual identification is specified. For this reason, it is preferable that the display 26a is subjected to a calibration so as to actually match the display color of the display 26a with the color defined by the ICC profile.

As described above, the XYZ values and the observance light source which are desired by the paint purchaser can be acquired. Thereafter, similar to the modified example described above, the paint representing the XYZ values under the observance light source is specified (step S119), and the sample sheet SS can be printed. On the other hand, in step S113, when it is determined that the region designating button is not clicked by the mouse 27b but the cancel button is clicked, or when no operation is carried out during a predetermined period, the popup image is erased (step S118), and then a predetermined operation is monitored (step S112).

In this modified example, it is possible to designate the favorite color by designating the region when the paint purchaser finds out the favorite color in the image which is displayed on the display 26a by the application APL such as the browser. Therefore, there is no need to grasp the colorific value of the favorite color. In addition, there is no need to prepare the sample of the paint in the agency store. For example, by browsing WEB pages which include many images of houses of building companies, it is possible for the paint purchaser to find out the paint to coat the roof of own house. Further, when the calibration is not completely performed in this modified example, the display color of the display 26a is also incorrect, so that the designation of the color by the paint purchaser is also incorrect.

For this reason, in consideration of deviation in the display color of the display 26a, several paints displaying colors approximated to the XYZ values desired by the paint purchaser are specified as well as the most approximated color, and the sample sheets SS of these may be printed, respectively. In this case, even when the display color of the display 26a is deviated, it is possible to select the most ideal color from among plural sample sheets SS. Further, the kind of the application APL is not limited to the browser, but for example, it may be a photo viewer so that the paint purchaser can designate the favorite color in any photograph owned by the paint purchaser. That is, the paint purchaser takes an object of the favorite color using a digital still camera or a scanner, and can designate the corresponding region while browsing the image data. Therefore, the paint purchaser can purchase the paint, with which a color from a favorite landscape photograph is reproducible, to coat a room or the like. In addition, according to the digital still camera, a concave-convex object can be also input as an image. Of course, a word processor or an application for the CG creation can also designate the favorite color. However, it may be also considered that the deviation occurs between the actual color of the object taken by the digital still camera and the color of the object displayed on the display 26a by the photo viewer. When the paint purchaser wants the paint having the color currently displayed on the display 26a, the deviation is not a problem. However, when the paint purchaser wants the paint having the color of the object itself, the sample sheet SS may be printed with the paint which is different from the intended paint. For this reason, by preparing a profile defining the correspondence relationship between the colorific value representing each pixel of the image taken by the digital still camera and the measured value of the actual object, it is preferable to carry out a color matching. Furthermore, a dedicated application APL may be provided which is suitable for designating the region representing the favorite color of the paint purchaser.

### H4. Fourth Modified Example

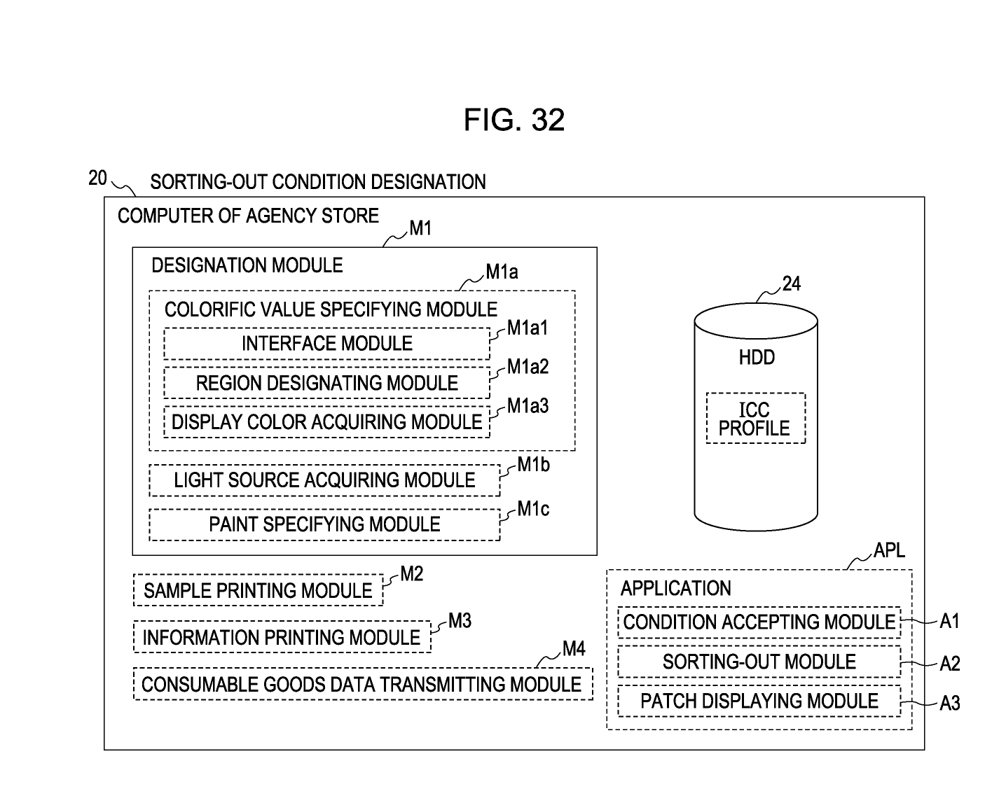

FIG. 32 shows a configuration of the application APL according to this modified example. The configurations of the other modules are the same as those of the third modified example. That is, even when the application APL of this modified example is performed, a popup image is displayed to designate the region in the display image which is displayed on the display 26a by the application APL by carrying out the call operation. The application APL is configured of the condition accepting module A1, a sorting-out module A2, and a patch displaying module A3.

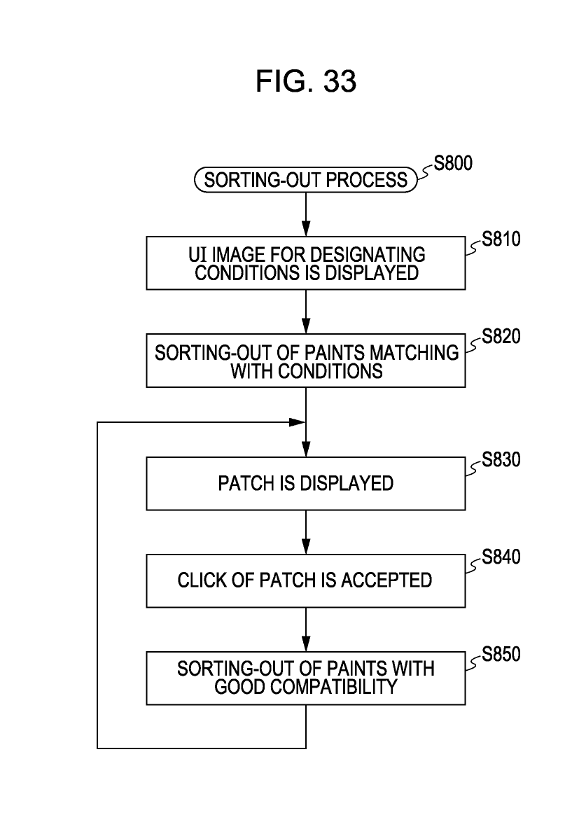

FIG. 33 shows a flow of a sorting-out process performed by the application APL. Also in performing this process, the monitoring of the call operation runs in the background by the interface module M1a1. In step S810, the condition accepting module A1 displays a condition designating image on the display 26a to accept the operation of the keyboard 27a or the mouse 27b.

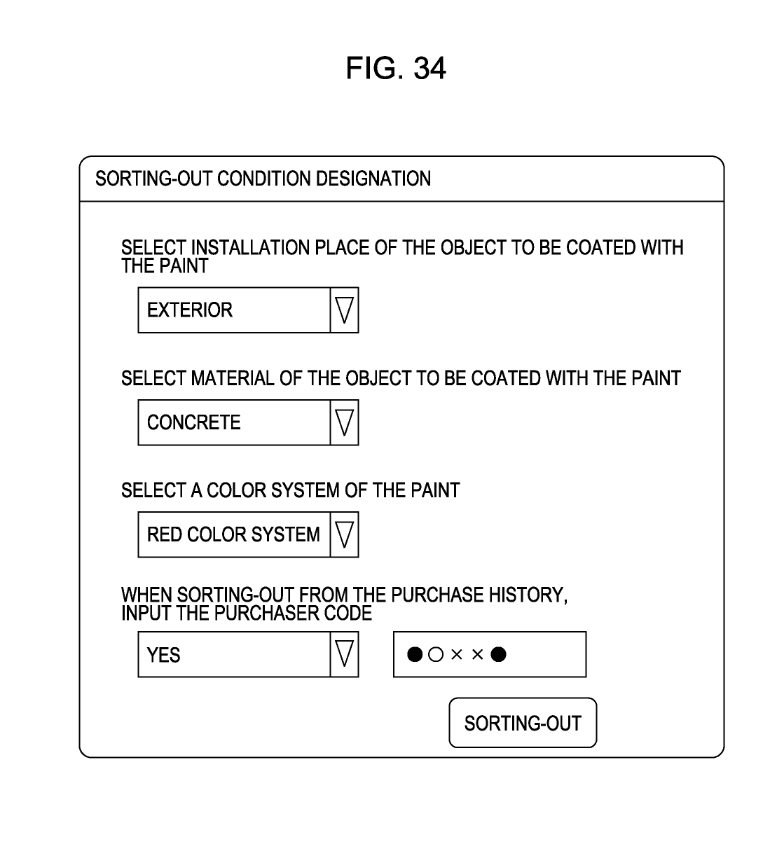

FIG. 34 shows an example of the condition designating image. In the condition designating image, pull down menus are provided to designate the coating object of the paint which the paint purchaser wants to purchase. Specifically, with these menus, the paint purchaser can designate whether the coating object is disposed in the exterior or in the interior, the material of the coating object, and the color system represented by the paint. In addition, a unique purchaser code is assigned to the paint purchaser, so that it is possible to designate whether or not the paint is limited to the own purchaser code and to ones already purchased in the past. In step S820, the sorting-out module A2 sorts out the paints suitable for the designated conditions. In the index table IDT according to this modified example, information is stored to perform the sorting-out on the respect paints.

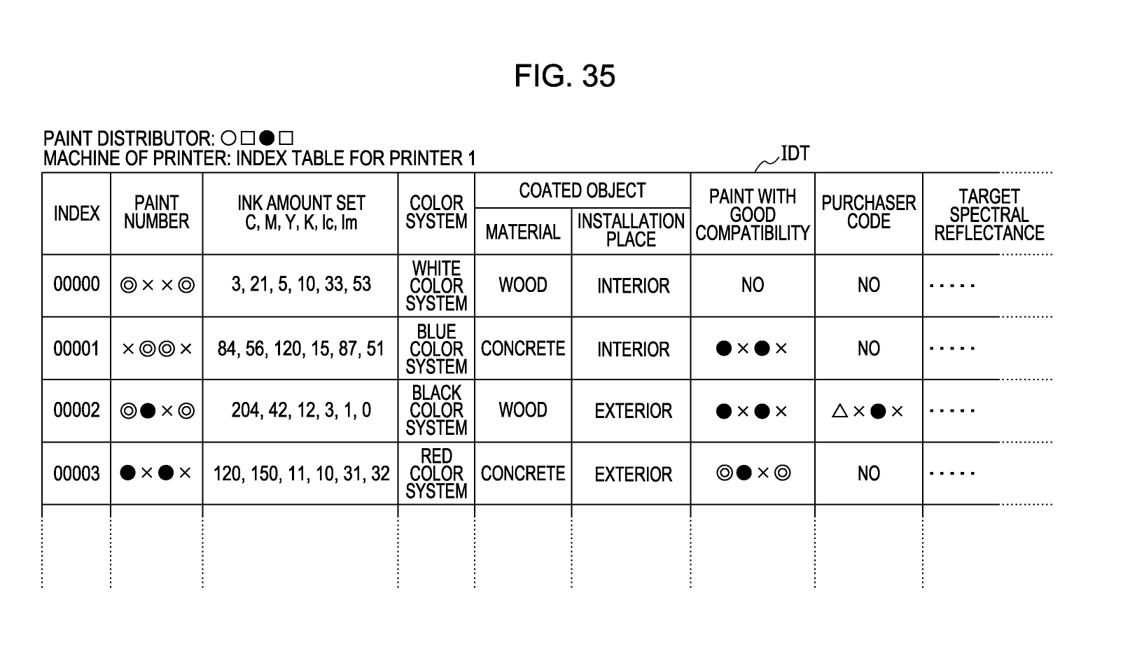

FIG. 35 shows an example of the index table IDT according to this modified example. In the index table IDT, whether the paint is used for the interior or for the exterior, the material with which the paint can be coated, the color system of the paint, and the purchaser code of the paint purchaser who purchased the paint in the past are stored as the sorting-out keys. In addition, the paints with good compatibility with the respective paints are stored in the index table IDT. The sorting-out module A2 sorts out the paints, which match with the respective items designated by the paint purchaser, by the sorting-out keys described above. Also in this case, in order to control the index table IDT to be accessed, the paints of which the license fee is paid by the paint distributor are sorted out. In step S830, the patch displaying module A3 displays the patches of the sorted-out paints on the display 26a. When displaying the patches of the sorted-out paints, the observance light source designated as the installation place is first applied to the target spectral reflectance Rₜ(λ) of the sorted-out paints and the XYZ values are calculated by calculating the above Equation 12. Then, the RGB values of the sRGB color space, in which the color equivalent to the XYZ values can be displayed on the display 26a, is specified with reference to the ICC profile described above.

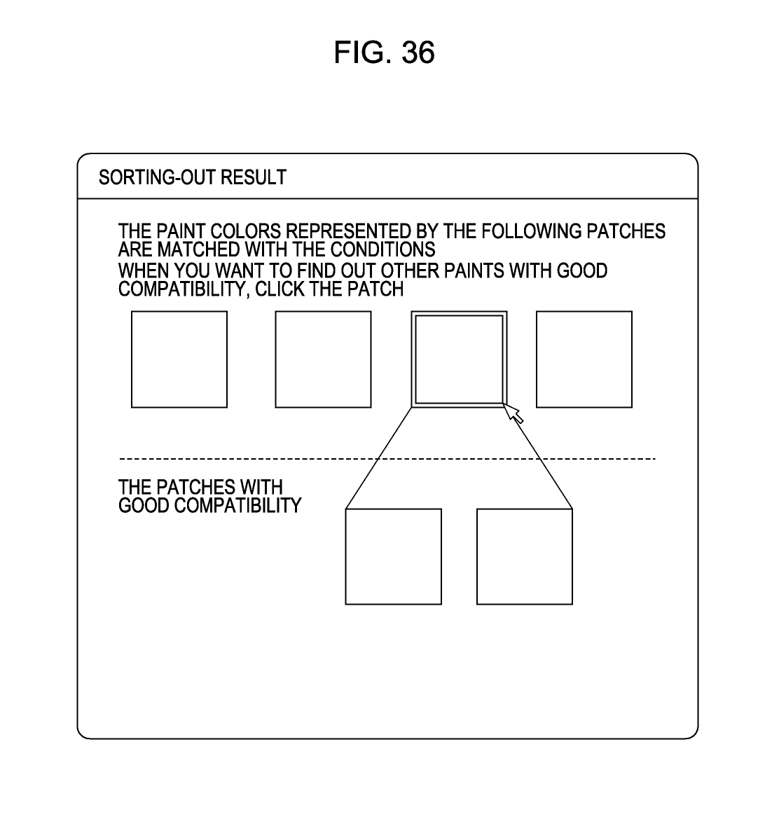

FIG. 36 shows an example of the patches displayed in step S830. In this drawing, the rectangular patches of the colors, which are represented by the plural sorted-out paints under the observance light source designated as the installation place, are arranged on the display 26a. The patches displaying module A3 aligns the pixels, which have the RGB values specified according to the above-mentioned procedure, on the display image data in a rectangular shape, and outputs the display image data to the video I/F 26, so that the patches are displayed on the display 26a. At this point of time, when the paint purchaser finds the favorite color among the patches, the interface module M1a1 makes the popup image by carrying out the call operation for monitoring, so that the paint purchaser can designate the region of the favorite patch. As a result, the process of the third modified example is carried out, and it is possible to print the sample sheet SS of the paint represented by the patch. Further, in the popup image, it may be restricted not to designate a conflicted observance light source.

On the other hand, the patch displayed in step S830 can be clicked by the mouse 27b. In step S840, the clicks of the respective patches are accepted. When the patch is clicked, the sorting-out module A2 sorts out the paint with good compatibility with the clicked patch (step S850). Since the paints with good compatibility with the respective paints are stored in index table IDT, the sorting-out module A2 can sort out the paints using the index table IDT. When the sorting-out is completed, the procedure returns to step S830 to display the patches of the sorted-out paint. At this time, the new patches are displayed in parallel so as to be viewed in contrast to the patches displayed from the beginning. At this point of time, when the paint purchaser finds the favorite color among the patches, the interface module M1a1 makes the popup image by carrying out the call operation for monitoring, so that the paint purchaser can designate the region of the favorite patch. In this way, the paints are sorted out according to the conditions designated by the paint purchaser, so that it is possible to smoothly designate the paints. In particular, when the paint purchaser wants to purchase the same paints as ones already purchased in the past, it is possible to smoothly designate the paints by designating the purchaser code. Also in this case, since the color can be confirmed by the patch, it is possible to prevent designation mistakes.

In addition, the shape of the patch is not limited to the simple rectangular shape, but the shape may be changed such that the patch having the shape (for example, the roof shape of the house) of the object for coating is displayed. That is, if the object for coating is specifically designated when the sorting-out conditions are designated, it is possible to display the patch according to the shape of the object for coating. As a result, the paint purchaser can easily visualize a coated state. In such a configuration, when one patch is clicked in step S840, the patch in the shape of the adjacent object (for example, the wall with respect to the roof of the house) may be displayed by the RGB values of the paint with good compatibility. Then, both patches are displayed in combination with each other, so that the paint purchaser can select the combination of the paints used to print the sample sheet SS while visualizing the color and the shape.

In addition, the index table IDT may be stored in the computer 10 of the paint distributor. The index table IDT is managed by the HDD 14 of the computer 10 of the paint distributor, so that it is possible to flexibly respond to the addition of new paint products. In addition, every time the delivery accounting process is carried out, it is preferable that the purchaser codes of the paint purchasers who purchase the respective paints be filled out. Further, it is preferable that the index table IDT be managed by the HDD 14 of the computer 10 of the paint distributor. In addition, the application APL of this modified example has been described to be performed on the computer 20 of the agency store. However, the computer 10 of the paint distributor actually performs the corresponding processes, and the computer 20 of the agency store may provide only the user interface using the browser or the like.

### H5. Fifth Modified Example

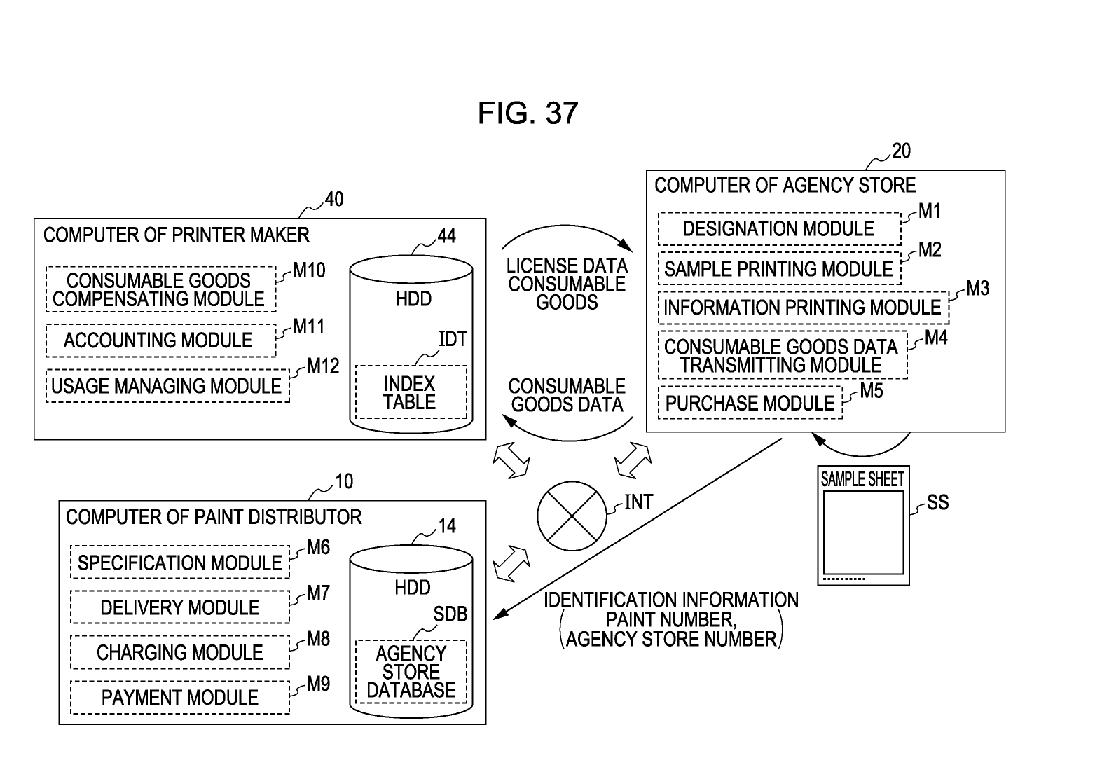

FIG. 37 shows a software configuration of the paint purchasing system according to this modified example. In this modified example, the computer 30 of the paint purchaser is not provided, and the purchase module M5 is performed by the computer 20 of the agency store. As a result, it is possible to flexibly respond to a case where the paint purchaser decides to purchase the sample sheet SS immediately after printing, or to a case where the paint purchaser first takes out the sample sheet SS to own house and then again returns back to the agency store to purchase it. In this case, a bar-code reader is provided at the computer 20 of the agency store, and a bar code obtained by encoding the paint distributor, the paint number, and the agency store number is printed on the sample sheet SS, so that it is possible to omit the troublesome inputting of the paint purchaser or the like.

### H6. Sixth Modified Example

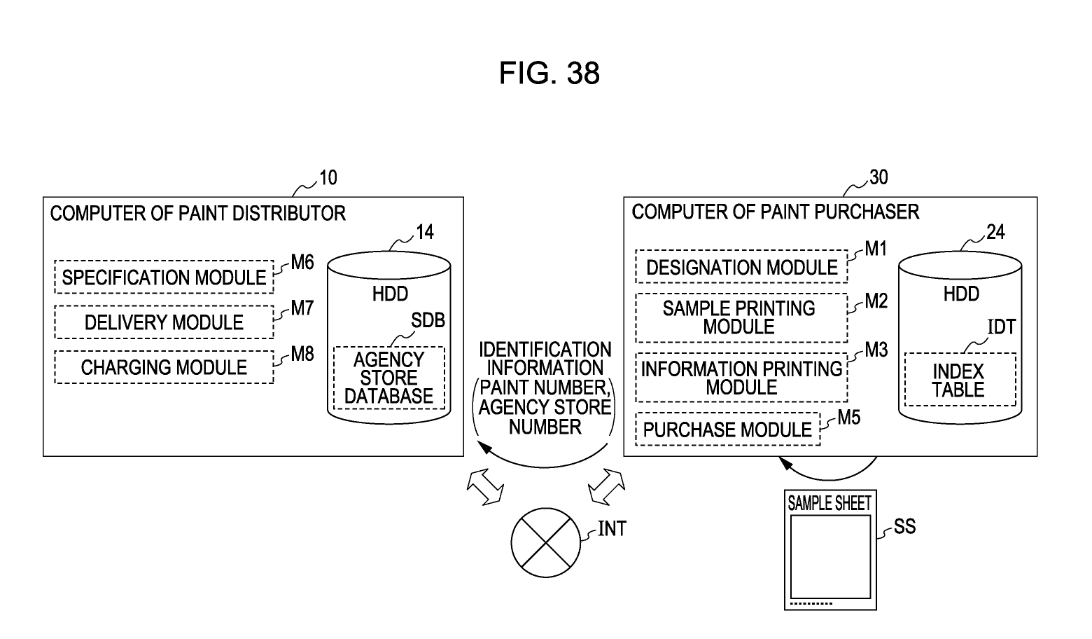

FIG. 38 shows a software configuration of the paint purchasing system according to this modified example. In this modified example, the computer 20 of the agency store is not provided, but the designation module M1, the sample printing module M2, and the information printing module M3 which carry out the sample sheet printing process are performed by the computer 30 of the paint purchaser. That is, the sample sheet SS may be printed by the computer 30 of the paint purchaser. In this case, the paint purchaser may not go to the agency store. In this modified example, since the trouble of printing the sample sheet SS and the burden of the consumable goods may be undertaken by the paint purchaser, the consumable goods data transmitting module M4, the payment module M9, and the consumable goods supplementing module M10 are not performed.

### H7. Seventh Modified Example

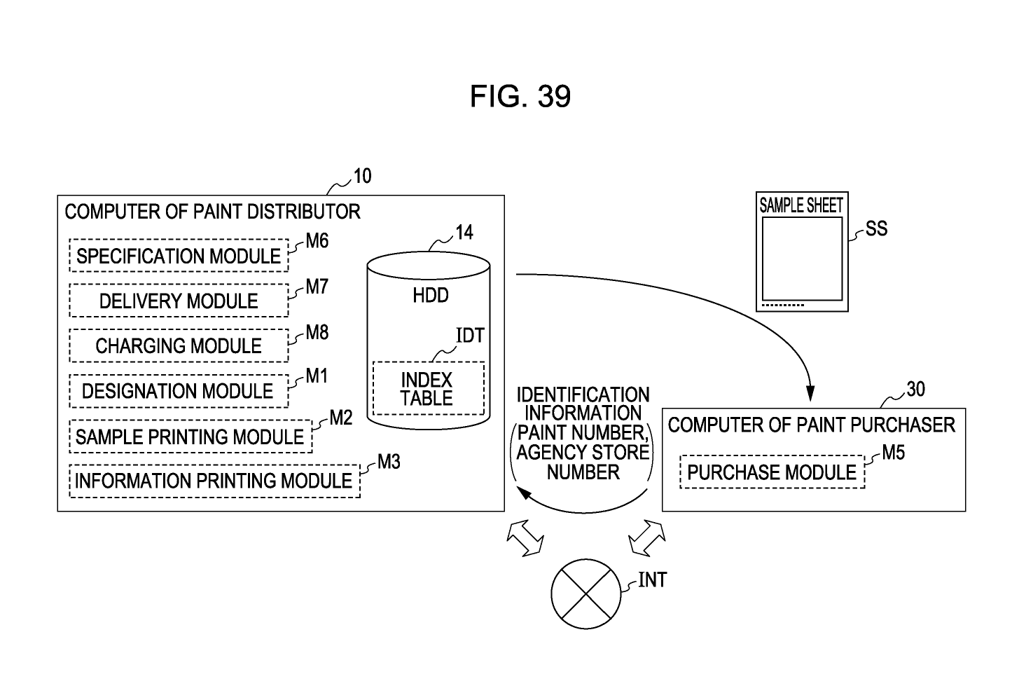

FIG. 39 shows a software configuration of the paint dealing system according to this modified example. In this embodiment, the computer 20 of the agency store is not provided, but the designation module M1, the sample printing module M2, and the information printing module M3 which carry out the sample sheet printing process are performed by the computer 10 of the paint distributor. That is, the sample sheet SS may be printed by the computer 10 of the paint distributor. In this modified example, since the trouble of printing the sample sheet SS and the burden of the consumable goods may be undertaken by the paint purchaser, the consumable goods data transmitting module M4, the payment module M9, and the consumable goods supplementing module M10 are not performed.

### I. Conclusion

As described above, in the merchandise dealing system of the invention, the computers are provided for the purchaser, the distributor, the agency store, and the printing manager and are connected to each other via the communication lines. Then, the computer of the agency store is provided with the sample printing unit, the information printing unit, and the consumable goods data transmitting unit. The sample printing unit causes the printing apparatus to print the merchandise sample, and the information printing unit prints the identification information for identifying the merchandise on the sample. Then the consumable goods data transmitting unit transmits the consumable goods data, for specifying the consumable goods which are exhausted by printing the sample, to the computer of the printing manager. On the other hand, the computer of the purchaser is provided with a purchasing unit that transmits the identification information printed on the sample to the computer of the distributor. The computer of the distributor is provided with the specifying unit and the charging unit. The specifying unit specifies the designated merchandise and the agency store in which the sample is printed on the basis of the transmitted identification information. The charging unit charges the cost of the designated merchandise to the purchaser. Therefore, the purchase and the payment of the cost between the purchaser and the distributor are completed.

In addition, the consumable goods supplementing unit and the accounting unit are provided at the computer of the printing manager. The consumable goods supplementing unit receives the consumable goods data and carries out the supplementing of the consumable goods which is exhausted by printing the sample. Then, the accounting unit charges the cost of the supplemented consumable goods to the distributor. By this, it is possible that the consumable goods are supplemented by the agent, who charges the cost required for the supplement to the distributor who is paid the cost of the merchandise from the purchaser. That is, from the paint distributor viewpoint, the cost of the consumable goods is considered as a cost required for sale of the merchandise. Further, the cost can be smoothly undertaken by the distributor.

The merchandise of the invention may be sufficient to be reproducible as the sample of the printed material. For example, the paint or the like is reproducible in the state of the coated surface using the sample which is subjected to solid printing. Of course, when the sample is a photograph of the merchandise, it is possible to print various samples such as general domestic articles or electrical articles. The combination of such samples is the so-called merchandise catalog. According to the invention, it is possible to provide the system in which the cost of the consumable goods exhausted by printing the catalog is smoothly accounted for.

As a specific method of printing the sample, the database is prepared in advance in which the correspondence relationship between the merchandise and the amount of the coloring material used by the printing apparatus when the sample are printed by the printing apparatus is defined. Then, the printing apparatus may be caused to print the sample by the coloring material obtained by referring to the database. The database may be managed by any one of the printing manager, the distributor, and the agent, but it is preferable that the printing manager or the distributor manage the database in order to flexibly respond to the update of the merchandise. In addition, the amount of the coloring material associated with the paint is corrected in each printing apparatus, so that deviation in reproduction accuracy of the printing apparatus may be suppressed with respect to the sample.

In addition, data necessary to cause at least the sample printing unit and the information printing unit to function is offered to the computer of the agency store, and the cost of the offering is charged to the distributor. As a result, the printing manager can obtain the license fee for using the sample printing unit and the information printing unit. Furthermore, when the consumable goods supplementing unit performs the supplement, it is preferable that the supplement frequency be adjusted. For this reason, when the accumulated total of the consumable goods exhausted in the agent reaches a predetermined supplement unit, it may be configured to supplement the consumable goods.

In addition, as a preferable specific example of the invention, it is configured such that the image data is generated when the sample is printed by the printing apparatus and the information on the pixels in the region corresponding to the paint sample is stored in order to uniquely specify the paint. In general, the image data subjected to the rendering in printing is configured of the pixels having the information for specifying a predetermined color space of the printing color, but the properties of the paint to be reproduced as the sample are not limited to the color. Specifically, the spectral reflectance or the metamerism of the paint is also to be reproduced, but at the point of time when the pixels is expressed to print the sample with the printing color in the image data, the information on the spectral reflectance or the metamerism is lost. For this reason, also in the rendered image data, the information on the pixels in the region corresponding to the sample is stored to enable the paint to be specified. On the other hand, the pixels of the region, in which the identification information is recorded, may be sufficient to store the information for specifying the printing color in a predetermined color space as usual.

In addition, the technical idea of the invention is realized by the specific hardware systems or the computers which constitute the system but as well as this, it can be realized as a method carried out on the system. That is, the invention can also be specified as a method which includes processes corresponding to the respective unit carried out by the system described above. Of course, when the above-mentioned system reads out programs to realize the respective unit described above, it is matter of course that the technical idea of the invention may be realized by programs which perform the functions corresponding to the respective units or by various recording media in which the programs are stored.

What is claimed is:

1. A merchandise dealing system comprising computers which are provided for a purchaser, a distributor, an agency store, and a printing manager and are connected to each other via a communication line,
wherein the computer of the agency store includes
a sample printing unit that causes a printing apparatus to print a merchandise sample,
an information printing unit that prints identification information on the sample to identify the merchandise, and
a consumable goods data transmitting unit that transmits consumable goods data to the computer of the printing manager to specify the consumable goods exhausted by printing the sample,
wherein the computer of the purchaser includes
a purchasing unit that transmits the identification information printed on the sample to the computer of the distributor,
wherein the computer of the distributor includes
a specifying unit that specifies the designated merchandise and the agency store which prints the sample on the basis of the transmitted identification information, and
a charging unit that charges a cost of the specified merchandise to the purchaser, and
wherein the computer of the printing manager includes
a consumable goods supplementing unit that receives the consumable goods data and supplements the consumable goods exhausted by printing the sample, and
an accounting unit that charges a cost of the supplemented consumable goods to the distributor.

2. The merchandise dealing system according to claim 1,
wherein the merchandise is a paint.

3. The merchandise dealing system according to claim 1,
wherein the sample printing unit refers to a database which defines a correspondence relationship between the merchandise and an amount of a coloring material used when the printing apparatus prints the sample, and obtains the amount of the coloring material to cause the printing apparatus to print the sample.

4. The merchandise dealing system according to claim 3,
wherein the computer of the printing manager corrects the amount of the coloring material associated with the merchandise in the database in every printing apparatus, and
wherein the sample printing unit refers to the corrected database.

5. The merchandise dealing system according to claim 1,
wherein the computer of the printing manager offers data necessary to cause at least the sample printing unit and the information printing unit to function to the computer of the agency store, and charges a cost of offering to the distributor.

6. The merchandise dealing system according to claim 1,
wherein the consumable goods supplementing unit is configured to supplement the consumable goods when an accumulated total of the consumable goods exhausted for the agent reaches a predetermined supplement unit.

7. The merchandise dealing system according to claim 1,
wherein the sample printing unit generates image data corresponding to a printed image when the printing apparatus is caused to print the sample,
wherein pixels of the image data in a region corresponding to the merchandise sample have information for uniquely specifying the merchandise, and
wherein pixels of the image data in a region on which the identification information is recorded have information for specifying a printing color in a predetermined color space.

8. A computer of a printing manager which is connected with a computer of an agency store via a communication line, the computer comprising:
a consumable goods supplementing unit that supplements consumable goods exhausted by printing a paint sample on the basis of consumable goods data which specifies the consumable goods exhausted by printing the sample using a printing apparatus provided at the computer of the agency store, and
an accounting unit that charges a cost of the supplemented consumable goods.
